(19) United States
(12) Patent Application Publication
(10) Pub. No.: US 2011/0010304 A1
(43) Pub. Date: Jan. 13, 2011

(54) DATA ASSOCIATION ENGINE FOR CREATING SEARCHABLE DATABASES

(75) Inventors: Frankie Chan Wong, Glendale, CA (US); David Chan Wong, Glendora, CA (US)

Correspondence Address: KNOBBE MARTENS OLSON & BEAR LLP, 2040 MAIN STREET, FOURTEENTH FLOOR, IRVINE, CA, 92614, US

(73) Assignee: E2G2, INC., Glendora, CA (US)

(21) Appl. No.: 12/670,355

(22) PCT Filed: Jul. 23, 2008
(86) PCT No.: PCT/US08/70902

§ 371 Date: Jul. 16, 2010

Related U.S. Application Data
(60) Provisional application No. 60/951,401, filed on Jul. 23, 2007.

(51) Int. Cl. G06Q 99/00; G06Q 30/00

(52) U.S. Cl. 705/317; 705/14.69; 705/14.72; 705/14.4

(57) ABSTRACT

A point-of-license data collection and indexing system comprises a form database, a business database, a data entry tool, a rules database, a data association engine, and a reporting tool. The data entry tool is configured to commence a data entry session and to receive data required to complete a business licensing form and non-license business data during the same session. The business database is configured to store the entered business data. The data association engine is configured to consult the rules engine and to determine associations between items of data stored in the business database to facilitate searching of the business database using a search engine. The reporting tool is configured generate reports based on the business database, to make the license business data accessible to a government, and to make the non-license business data accessible to the public using a search engine.

### CROSS-REFERENCE TO RELATED APPLICATIONS

This application claims priority to U.S. Provisional Patent Application No. 60/951,401, filed Jul. 23, 2008. The entire disclosure of the foregoing provisional patent application is hereby incorporated-by-reference into this application.

### BACKGROUND

1. Field of the Invention

Embodiments disclosed herein relate to the collection, indexing, and searching of business, government, and organization data.

2. Description of the Related Art

Today's consumers are unable to easily search for and successfully obtain a complete list of legitimate and “legal” providers of particular products or services in their area, whether by using a cell phone, a PDA or a computer. Indeed, they cannot conveniently obtain a complete and accurate list of all licensed pizzerias, sporting goods stores or churches in their area, or find out quickly what are the hours of operation—or other details—of such businesses and organizations.

Currently, phonebooks are incomplete and, for example, do not offer hours of operation for all businesses. This and other detailed business information often must be obtained by telephone with an expensive information call and an often lengthy and tedious navigation of an unhelpful menu of options. This business information is not readily available on line via the Internet either, and certainly is not available in one convenient place for all businesses in a given city or geographic area. When trying to find detailed business information by using local websites, one only discovers that this information is very difficult if not impossible to find and/or that it is inaccurate or incomplete. Thus, for example, with existing tools it is very difficult to compare which businesses are open early or late. One reason why this information is not updated and available is because it is very expensive to collect and maintain and very few companies attempt to provide or update this information.

Unlike in days of land lines when one could obtain an updated and complete list of business telephone numbers for an area from the telephone company, today there are no centralized repositories or single source locations from which to obtain this information. Updated and complete list of business cell phone numbers are even more difficult to obtain since these lists are compiled over a number of different wireless companies. Residents or consumers who simply want to familiarize themselves with their own community and locate clubs, associations, churches, professional or public service organizations, find it challenging as there is no uniform, consistent, central place where organizations can list and update their information.

Businesses have no effective way to make their descriptive information available to local consumers. Presently, there is no formalized or centralized place in a city where businesses and organizations can list their detailed business information where it would be conveniently and easily located by local residents and consumers.

In fact, businesses have no convenient way to integrate themselves into a community. It is time-consuming and tedious for businesses—particularly new businesses—to evaluate, to compare and to decide upon the best ways to advertise their products and services, and, even when a budget is available in a new or early stage business, there is no convenient resource available to ease the effort and help a business to select appropriate advertising media and to commence early and effective advertising. Nor is there any convenient way for a business to quickly and easily locate other services and products that it needs to conduct its business. Additionally, some businesses find it difficult to gain bid access to various proposals and projects for which their products and services are well-suited. Furthermore, businesses do not have effective access to information exchange that would help them to play a positive role in their local community—e.g., to sponsor worthy events or youth sports teams, assist a local school, church or youth organization, or hire local persons—possibly seniors and students.

Businesses do not even have a convenient way to apply for a business license. Most local government licensing agencies have not facilitated, allowed or accepted online business license applications. Generally, a business license application must be submitted on paper. License applicants have no choice but to continue to process applications using the postal system or face-to-face. When submitted, the license application information is manually processed into a government computer system.

The various participants or stakeholders in a local community, such as government, business, organizations, schools, information and advertisement publishers, local and global search engines and residents/consumers all share direct or indirect relationships. Yet, within and between each community all these stakeholders operate separately and differently with their own constraints, platforms, formats, standards, interfaces, networks and systems. As a result, specific constraints, issues, problems and challenges created by the interrelationships between parties within a local community have been difficult to address and solve.

What is needed is an information collection and distribution system and method that addresses the problems mentioned above and others, that is positioned for convenient use and that permits businesses and other stakeholders in local communities or other areas to easily provide information about themselves, to easily obtain useful information from other stakeholders, and to integrate themselves effectively within the community.

Business licenses generally allow individuals or companies to conduct business within a geographical jurisdiction. A single jurisdiction, or local government often requires multiple licenses and permits that are issued by multiple government departments and agencies. The requirements for business licenses vary between countries, states, and local municipalities. There are often many licenses, registrations and certifications required to conduct a business in a single location. A business license or permit registration program can be used for tracking purposes, but many jurisdictions go beyond registration and in most cases licensing operations are used for enforcement as well as for tax and revenue generation. Based on typical methods, obtaining a license or permit to do business is a time consuming process and may involve significant monetary expenditures.

### SUMMARY

One embodiment is a point of license system comprising: at least one computer processor; a memory; a data transmission port; a data reception port; and a program stored at least in part in the memory which, when executed by the at least one computer processor, generates first output signals transmitted from the data transmission port to prompt a user to provide first business license data, the first business license data representing information useful for determining whether to issue a business license, the program responsive to first input signals received at the data reception port representative of the first business license data to generate second output signals transmitted from the data transmission port to prompt a user to provide first non-business license data, the first non-business license data indicative of at least one advertising decision made by the user.

In the foregoing embodiment, the program may be responsive to second input signals received at the data reception port representative of the first non-business license data to generate third output signals transmitted from the data transmission port to inform at least one advertiser about the at least one advertising decision made by the user. The data transmission port and the data reception port may be the same port.

One embodiment is a point of license system comprising: at least one computer processor; a memory; a data transmission port; a data reception port; and a program stored at least in part in the memory which, when executed by the at least one computer processor, generates first output signals transmitted from the data transmission port to prompt a user to provide first business license data, the first business license data representing information useful for determining whether to issue a business license, the program responsive to first input signals received at the data reception port representative of the first business license data to generate second output signals transmitted from the data transmission port to prompt a user to provide first non-business license data, the first non-business license data indicative of at least one sponsorship decision made by the user.

In the foregoing embodiment, the sponsorship decision may indicate whether the user will agree to sponsor an event or an organization. The program may be responsive to second input signals received at the data reception port representative of the first non-business license data to generate third output signals transmitted from the data transmission port to inform another party about the at least one sponsorship decision made by the user. The data transmission port and the data reception port may be the same port.

One embodiment is a point of license system comprising: at least one computer processor; a memory; a data transmission port; a data reception port; and a program stored at least in part in the memory which, when executed by the at least one computer processor, generates first output signals transmitted from the data transmission port to prompt a user to provide first business license data, the first business license data representing information useful for determining whether to issue a business license for a first business, the program responsive to first input signals received at the data reception port representative of the first business license data to generate second output signals transmitted from the data transmission port to prompt a user to provide first non-business license data, the first non-business license data indicative of at least one bid registration decision made by the user.

In the foregoing embodiment, the bid registration decision may indicate whether the user will agree to register the first business to receive information about items for which the first business may submit bids. The program may be responsive to second input signals received at the data reception port representative of the first non-business license data to generate and store data indicating that the first business is registered to receive information about items for which the first business may submit bids. The data transmission port and the data reception port may be the same port.

One embodiment is a license application system comprising: at least one computer processor; a memory; a communication port; a data entry device; and a program stored at least in part in the memory which, when executed by the at least one computer processor, receives first input signals from the communication port, the first input signals representing one or more prompts prompting a user to provide first business license data, the first business license data representing information useful for determining whether to issue a business license for a first business, the program responsive to first data entry signals received from the data entry device to generate first output signals transmitted to the communication port, the first output signals representative of the first business license data, the program responsive to second input signals received from the communication port to prompt a user to provide first non-business license data, the first non-business license data indicative of at least one advertising decision made by the user.

In the foregoing embodiment, the advertising decision may indicate whether the first business will agree to advertise products or services. The second input signals may represent at least one manner in which products or services may be advertised.

One embodiment is a license application system comprising: at least one computer instruction processor; a memory; a communication port; a data entry device; and a program stored at least in part in the memory which, when executed by the at least one computer instruction processor, receives first input signals from the communication port, the first input signals representing one or more prompts prompting a user to provide first business license data, the first business license data representing information useful for determining whether to issue a business license for a first business, the program responsive to first data entry signals received from the data entry device to generate first output signals transmitted to the communication port, the first output signals representative of the first business license data, the program responsive to second input signals received from the communication port to prompt a user to provide first non-business license data, the first non-business license data indicative of at least one sponsoring decision made by the user.

In the foregoing embodiment, the sponsoring decision may indicate whether the first business will agree to sponsor an event or an organization. The second input signals may represent at least one sponsorship opportunity.

One embodiment is a license application system comprising: at least one computer instruction processor; a memory; a communication port; a data entry device; and a program stored at least in part in the memory which, when executed by the at least one computer instruction processor, receives first input signals from the communication port, the first input signals representing one or more prompts prompting a user to provide first business license data, the first business license data representing information useful for determining whether to issue a business license for a first business, the program responsive to first data entry signals received from the data entry device to generate first output signals transmitted to the communication port, the first output signals representative of the first business license data, the program responsive to second input signals received from the communication port to prompt a user to provide first non-business license data, the first non-business license data indicative of at least one bid registration decision made by the user.

In the foregoing embodiment, the bid registration decision may indicate whether the user will agree to register the first business to receive information about items for which the first business may submit bids. The program may be responsive to second data entry signals received from the data entry device to generate second output signals transmitted to the communication port, the second output signals representative of the at least one bid registration decision.

One embodiment is a point-of-license data collection and indexing system comprising: a form database comprising electronic forms that each define data fields for license business data that a business is requested to provide to apply for a license; a business database configured to store license business data and non-license business data comprising business data that a business is not required to provide to apply for a license; a data entry tool configured to commence a data entry session, to retrieve at least one of the electronic forms from the forms database, serve the defined data fields to a web browser during the data entry session such that the web browser can prompt a user to enter data associated with the defined data fields, serve additional data fields to the web browser during the data entry session seeking non-license business data such that the web browser can prompt the user to enter data associated with the additional data fields, to receive license business data and non-license business data from the web browser, and to cause the license business data and the non-license business data to be stored in the business database; a rules database comprising information defining rules for determining associations between items of data stored in the business database; a data association engine configured to use rules stored in the rules database to determine associations between items of data stored in the business database so as to organize the business database to allow the business database to be searched using a search engine; and a reporting tool configured to search the business database and generate reports based on the business database, to make at least a portion of the license business data accessible to a government, and to make at least a portion of the license and non-license business data accessible to the public using a search engine.

The foregoing embodiment may also have form design tools configured to allow a government user to define forms for entry into the form database. It may also have a standard questions database comprising common data fields for a licensing form, wherein the form generation tools comprise a standard questions selector configured to allow the government user to select one or more of the common data fields stored in the standard questions database for inclusion on a form. It may also have a fee calculation rules database comprising calculation rules that may be combined to define fee calculation logic for calculating fees for a business applying for a license, wherein the form generation tools comprise a fee calculation definition tool configured to allow the government user to select and combine one or more of the fee calculation rules to define fee calculation logic. The fee calculation rules may be associated with business classifications and the fee calculation definition tool may be configured to allow the government user to define fee calculation rules that are specific to businesses having particular classifications. The system may also have an advertising vendor database comprising associations between advertising options and business characteristics and an advertisement selector configured, during the data entry session, to determine one or more advertising options for the business for which data is being entered, the determination being based on at least one business characteristic of the business and at least one association between the business characteristic and at least one advertising option, and to present the advertising options to the business for selection. It may also have an organization database comprising information about organizations and opportunities to sponsor the organizations and associations between the organizations and opportunities of sponsorship and business characteristics, and a sponsorship tool configured, during the data entry session, to determine one or more sponsorship opportunities for the business for which data is being entered, the determination being based on at least one business characteristic of the business and at least one association between the business characteristic and at least one organization or sponsorship opportunity, and to present the sponsorship opportunities to the business for selection. It may also have a business opportunity database comprising information about opportunities for businesses to enter into business transactions and associations between the business opportunities and business characteristics, and a business opportunity search tool configured to find one or more business opportunities for a business, the determination being based on at least one business characteristic of the business and at least one association between the business characteristic and at least one business opportunity, and to present the business opportunity to the business for response.

One embodiment is a point-of-license data entry system comprising: a display; a data entry device; and a terminal configured to commence a data entry session, to receive license data fields pertaining to data that a business is requested to provide in a process of applying for a license, to receive non-license data fields seeking non-license business data pertaining to data that the business is not required to provide in the process of applying for a license, to prompt a user to enter information during the session into the license data fields and the non-license data fields, and to transmit the entered information for storage in a business database, wherein the non-license data fields include hours of operation of the business.

In the foregoing embodiment, the terminal may be further configured to receive, during the data entry session, one or more advertisement options chosen based on an association between at least one characteristic of the business and the advertisement options, and to select one or more of the advertisement options so as to begin a process of advertising the business via the selected advertisement options. The terminal may also be configured to receive, during the data entry session, one or more organization sponsorship options chosen based on an association between at least one characteristic of the business and the organization sponsorship options, and to select one or more of the organization sponsorship options so as to begin a process of sponsoring organizations in accordance with the selected advertisement options. The terminal may also be configured to receive one or more business opportunities chosen based on an association between at least one characteristic of the business and the business opportunities, to allow a user to enter a response to the business opportunities, and to transmit the response.

One embodiment is a method of providing a service at a point-of-license, the method comprising: executing a computer-based process to commence a business license data entry session; obtaining first business data from an applicant for a business license during the data entry session; and obtaining advertising data from the applicant during the data entry session, the advertising data indicative of a decision to advertise products or services related to the first business data.

The foregoing method may further comprise presenting a first set of advertising options to the applicant during the data entry session. The method may further comprise selecting the first set of advertising options based on a relationship between the first business data and each advertising option in the first set. The method may further comprise: storing advertising options; associating one or more business characteristics with each of the stored advertising options; selecting a first set of advertising options based on the first business data matching at least one business characteristic that is associated with each of the first set of advertising options; and presenting the first set of advertising options to the applicant for selection by the applicant. The method may further comprise charging the applicant a fee for advertising services.

One embodiment is a method of providing a service at a point-of-license, the method comprising: executing a computer-based process to commence a business license data entry session; obtaining first business data from an applicant for a business license during the data entry session; and obtaining organization sponsorship data from the applicant during the data entry session, the organization sponsorship data indicative of a decision to sponsor an organization having a relationship to the first business data.

The foregoing method may further comprise presenting a first set of organization sponsorship options to the applicant during the data entry session. The method may further comprise selecting the first set of organization sponsorship options based on a relationship between the first business data and each organization sponsorship option in the first set. The method may further comprise: storing organization sponsorship options; associating one or more business characteristics with each of the stored organization sponsorship options; selecting a first set of organization sponsorship options based on the first business data matching at least one business characteristic that is associated with each of the first set of organization sponsorship options; and presenting the first set of organization sponsorship options to the applicant for selection by the applicant. The method may further comprise charging the applicant a fee for organization sponsorship services. The method may further comprise: requesting approval from an organization selected for sponsorship; and performing a transaction related to sponsorship of the organization upon receiving approval from the organization of the sponsorship.

One embodiment is a method of providing a service at a point-of-license, the method comprising: executing a computer-based process to commence a business license data entry session; obtaining first business data from an applicant for a business license during the data entry session; obtaining an indication from the applicant during the data entry session that the applicant wants to have access to business opportunities related to the first business data; granting access to the business opportunities; selecting a first set of business opportunities related to the first business data; and presenting the first set of business opportunities to a business user associated with the applicant.

The foregoing method may further comprise receiving a request from the business user associated with the applicant to search for business opportunities related to the first business data. The method may further comprise receiving a request from the business user to receive alerts of business opportunities, wherein the operation of selecting a first set of business opportunities is performed periodically, and wherein the operation of presenting the first set of business opportunities is performed by transmitting the first set of business opportunities to the business user. The method may further comprise: storing business opportunities; associating one or more business characteristics with each of the stored business opportunities; and selecting the first set of business opportunities to the business user based on the first business data matching at least one business characteristic that is associated with each of the first set of business opportunities. The method may further comprise charging the applicant a fee for business opportunity services.

One embodiment is a point of license system comprising: at least one computer instruction processor; a memory; a data transmission port; a data reception port; and a program stored at least in part in the memory which, when executed by the at least one computer processor, generates first output signals transmitted from the data transmission port to prompt a user to provide first business license data, the first business license data representing information useful for determining whether to issue a business license for a first business, the program responsive to first input signals received at the data reception port representative of the first business license data to generate second output signals transmitted from the data transmission port to prompt the user to provide first non-business license data, the first non-business license data descriptive of at least one aspect of the first business, the program generating third output signals transmitted from the data transmission port to prompt the user to provide second non-business license data, the second non-business license data representing a decision as to whether the first business will agree to advertise products and services, the program generating fourth output signals transmitted from the data transmission port to prompt the user to provide third non-business license data, the third non-business license data representing a decision as to whether the first business will agree to sponsor at least one event or organization, the program generating fifth output signals transmitted from the data transmission port to prompt the user to provide fourth non-business license data, the fourth non-business license data representing a decision as to whether the first business will agree to receive information about items for which it may submit bids.

In the foregoing point of license system, the program may use first non-business license data received at the data reception port to select first advertising options and generates sixth output signals transmitted from the data transmission port, the sixth output signals representative of the selected advertising options. The program may use first non-business license data received at the data reception port to select sponsorship options and generates sixth output signals transmitted from the data transmission port, the sixth output signals representative of the selected sponsorship options. The system may further comprise: a search engine; and a database, wherein the first business license data includes geographical information describing a location of the first business, wherein the program stores the geographical information in the database in association with the first business, wherein the program stores the first non-business license data in the database in association with the first business, and where the search engine receives search parameters including a first parameter indicative of a geographical region and a second parameter indicative of an aspect of a business, and compares the first parameter to the geographical information stored in the database and compares the second parameter to the first non-business license data in the database and generates search result information indicative of the first business. The data transmission port and the data reception port may be the same port.

One embodiment is a point of license system comprising: at least one computer processor; a memory; a data transmission port; a data reception port; and a program stored at least in part in the memory which, when executed by the at least one computer processor, generates first output signals transmitted from the data transmission port to prompt a user to provide first business license data, the first business license data representing information useful for determining whether to issue a business license for a first business, the program responsive to first input signals received at the data reception port representative of the first business license data to generate second output signals transmitted from the data transmission port to prompt a user to provide first non-business license data, the first non-business license data descriptive of at least one aspect of the first business, the program responsive to second input signals received at the data reception port representative of the first non-business license data to generate third output signals indicative of at least one selected product or service, the program comparing at least a portion of the first non-business license data to stored information representing one or more attributes of each of a plurality of products and services to select the at least one selected product or service.

In the foregoing point of license system, the third output signals may be transmitted from the data transmission port. The data transmission port and the data reception port may be the same port.

In some embodiments, the present invention is a system and method for efficiently processing business licenses, permits and registration of (local) community service, non-profit organizations, clubs, churches, associations, schools and the like. The system can be used by government agencies that require licenses and permits to track business and generate revenues to create, tailor and activate an automated, interactive licensing system based on its own local laws, ordinances, requirements, regulations and codes. In addition, the government agency can elect to include the option of registering, processing and promoting community organizations to its local residents. While completing the licensing application at the “point-of-license” the system can be used by a business to access, compare, select, process and purchase local and global advertising, as well as, input other information that link to marketing, sales and promotional opportunities, particularly those that target the local community. In addition, the system can be used to collect a variety of other useful information about the business such as description, history, facilities, hours of operation, current contact info, products and services.

The term “point-of-license” refers to business users entering information or being offered services at or near the time that they enter business information during the process of seeking a business license. In some embodiments, a data entry system starts a session in which a business user is prompted to enter business data that a city requires as part of the process of applying for a business license and the system also prompts the business user to enter additional information or presents the business user with the option for other value-added services during the same session. Alternatively, a business user is prompted to enter business data that a city requires as part of the process of applying for a business license and the system follows up with the business user to request additional information or to present the business user with services within a short time, such as, for example, within 5 minutes, 15 minutes, 30 minutes, an hour, three hours, five hours, eight hours, twelve hours, a day, or a week. Advantageously, by requesting the additional information or presenting the services within a time that is at or near the time that the business user enters data related to the licensing process, the system increases user participation in entering additional data or accepting services, increases the accuracy of the entered data, and increases the timeliness of the entered data.

The system and method of the present invention facilitates and manages the relationship between and among local communities' stakeholders that include, but not limited to, business, government, clubs/associations, schools, advertising vendors, local and global search engines, consumers, and other users. This facilitation and management may be performed across multiple cities/government entities. The present invention minimizes and overcomes the problems, inefficiencies and disconnected interactivities of traditional methods encountered by these stakeholders by, implementing novel methods and systems and integrating services and information that are currently provided by multiple entities on multiple platforms and in multiple formats through a centralized, unified system, or “virtual hub” within a single, uniform, interactive, integrated network, which may advantageously be centrally operated by a single entity, that analyzes, plans, coordinates, organizes, networks, implements, redistributes, and uses the information that government agencies have mandated, gathered and/or assembled.

In some embodiments, a system of the present invention is accessed through the Internet via a web browser that links to an interactive user-provided information interface. Upon inputting the user (stakeholder) information, the system automatically analyzes the information based on a proprietary knowledge base of applications, status, filters, data, content, rules, business processes and formulas that cross references the different individual entities individually and collectively to render back user tailored information to create a “one-stop”, value-added, local experience. For example, a new business applying for a license/permit is served up a tailored application that includes: a customized introduction; a training and educational package as to what is required for compliance and a step-by-step, guided, interactive process to complete the license application. The system and method provides for responses that are highly relevant and individualized based on specific user input and feedback, e.g. a massage and spa business has entirely different codes, rules, regulations, requirements and considerations than a manufacturing business that handles highly toxic chemicals that may pose environmental concerns and hazardous conditions. Furthermore, if the business has multiple locations and is part of a larger enterprise, the system retrieves any existing information and if requested, can recall the restored information to submit applications to other cities.

In some embodiments, the invention includes and generates a list of specific licensing requirements and conditions and additional customized forms to be completed, such as building, health and safety requirements. The invention also includes a list of advertising and marketing (global or local) options, based on the category or classification of the business, that a user can select, process and purchase. Optionally, the system and method of the present invention provide options to participate in a business or residential “welcome wagon,” bidding on city contracts, and/or options to join or sponsor a local club or organization.

In some embodiments, the invention facilitates dynamic creation, exchange, access and use of timely “licensed-certified” and other user generated local information from various entities in a community. The invention enables information to be delivered to many communication access points, for example, Internet, mobile devices, cell phones, faxes, prints, local and global search engines, and the like. In some embodiments, the web-based, user-driven, one-stop, point-of-license interface provided by the invention can be applied for example through a physical kiosk that can be widely distributed and located to provide convenience and easy access for businesses to process license applications and for consumers, and other stakeholders, to access information.

In some embodiments, the invention relates to systems and methods that integrate (online and offline) licensing and registration of businesses and organizations (clubs, associations, non-profits, service organizations, churches, schools) by government agencies, within a central “city based” registry, and more particularly processes for businesses to connect with advertising vendors and local and global search engines to advertise, promote and market themselves; and processes for businesses and/or organizations to interact with various segments (government, schools, clubs/associations, resident/consumers and businesses) of a local city, town or community by providing updated, useful information, products and/or services.

### BRIEF DESCRIPTION OF THE DRAWINGS

FIG. 1 is an illustration of a typical process by which a business obtains a business license.

FIG. 2 illustrates a Business Organization Licensing System in accordance with one embodiment.

FIG. 3 is a diagram illustrating an embodiment of the BOLS system for the community of stakeholders comprised of business, government, search engines, schools, organizations, advertisers and consumers.

FIG. 4 depicts communication systems commonly in use that may be accommodated in BOLS.

FIG. 5 is a block diagram of BOLS in accordance with one embodiment.

FIG. 6 is a block diagram of the advertising and marketing opportunities at the point-of-license.

FIG. 7 is a block diagram illustrating the embodiments of BOLS licensing process that creates a unique knowledge base and database that contains business and other information.

FIG. 8 is an diagram illustrating that BOLS creates a “virtual hub” that connects together local government, local businesses, local organizations and associations, local schools, and the local community.

FIG. 9 is a diagram illustrating BOLS availability of data from multiple government entities.

FIG. 10 is a diagram depicting the relationship between BOLS and stakeholders.

FIGS. 11A and 11B are a block diagram depicting one embodiment of a point-of-license business data collection system in accordance with the present invention.

FIG. 12 is a process flow diagram that illustrates how components of one embodiment of the system perform a process of collecting business data at the point-of-license and generating a search engine of localized business data.

FIG. 13 is a flowchart depicting one embodiment of a process of creating an electronic license form.

FIG. 14 is a flowchart that depicts one embodiment of a process of presenting advertising options at the point-of-license.

FIG. 15 is a flowchart that depicts one embodiment of a process of presenting options for sponsoring organizations at the point-of-license.

FIG. 16 is a flowchart that depicts one embodiment of a process of providing access to a business opportunity service at the point-of-license.

FIG. 17 is a flowchart that depicts one embodiment of a process of generating and displaying a report based on business data entered at the point-of-license.

FIGS. 18A, 18B, and 18C are illustrative worksheets that assist a user to create fee calculation logic without programming experience.

### DETAILED DESCRIPTION OF EMBODIMENTS

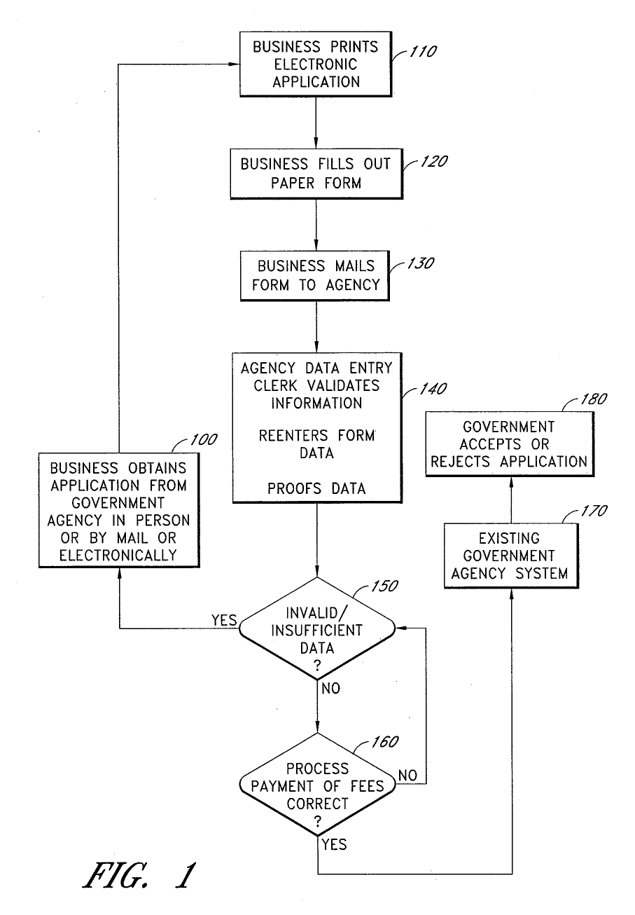

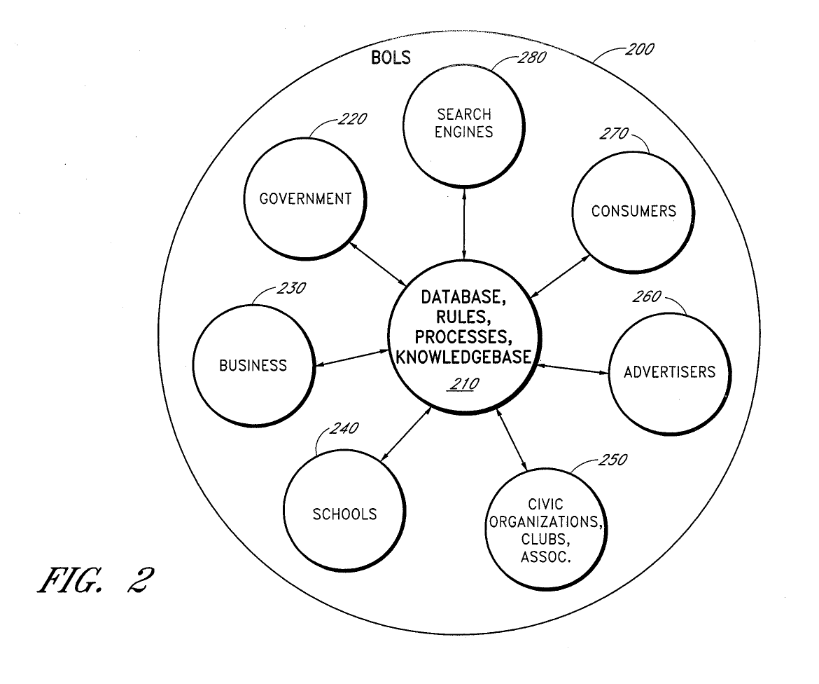

FIG. 1 is an illustration of a typical process by which a business obtains a business license. Though this process is relatively uniform throughout most government entities, there is no uniform standard or mechanism to enable the license content and information to be easily accessed within a city nor is there any uniform standard or mechanism to enable license content and information from different cities to be gathered and combined to provide the ability to all the different entities in all the different communities to interact with each other with any degree of confidence. For example, if a consumer were to try to find a plumber off line, typically, the consumer cannot be sure that they have access to all the licensed plumbers within the area, be sure the plumber is even a legitimately licensed business, i.e., the plumber has a valid and current license and/or permit to perform business in that governmental jurisdiction. Furthermore, the consumer utilizing a search engine on the Internet to find a suitable, local plumber is limited to those plumbers who advertise or are somehow linked to the Internet effectively eliminating valid, licensed businesses who do not advertise in this medium.

As shown in 100, in common practice, a new business—or in the case of an existing business renewing an existing license—obtains an application package, physical paper forms, through a telephone call by mail, or in person, by visiting the local government agency office or place designed as a form repository. Alternatively, if the business has access to the Internet, and, if the government agency offers it, an application may be electronically downloaded and printed in a paper format, as shown in 110. Next in 120, the business completes the business license application form by providing information in the spaces reserved for this purpose. Then, the business mails the form back or personally delivers the form back to the government agency in 130. Next as illustrated in 140, a government agency clerk receives the application, reviews and proofs the information, confirms the amount paid and the correct fee required by the type of business specified in the application, processes the payment in 160, and re-enters the information provided by the business, along with the confirmation of fees paid, into an existing government agency computer. The government computer system records the input and displays it for confirmation of accuracy with the business provided data. If everything is approved and accepted, the data contained in the application may be confirmed and recorded in the government agency computer database, in 170. As depicted in 140 and 150, during the validation and proof process, if information or payment as shown in 160, is determined to be missing, invalid, incorrect or insufficient the application is returned to the business for correction and to restart the process in 100.

In a block 180, the government accepts or rejects the application. The process of accepting or rejecting the application is typically a manual process.

In a typical process, for a business to research, find, compare, evaluate, decide and to purchase one or multiple types of advertising can be a time-consuming, costly and tedious process. For example, the choices for “localized” advertising media that cover a limited geography are numerous considering the choices in types of media (include, but not limited to newspaper, radio, television, coupon books, telephone directories, billboards, sponsorships) and the number of vendors (varies from one person vendors to national and international affiliates). Include some of the difference options such as coverage, distribution, price, deadlines and the decision process becomes even more complex. The Internet and its possible choices (local focus versus global, general versus target audience, click versus pay for performance) adds another layer of complexity. In this situation, there is considerable inefficiencies in terms of time, cost and ability to make better choices. For example, in the case of a new business, the activities of applying for a business license and considering making advertising decisions have been treated as separate and only indirectly related activities.

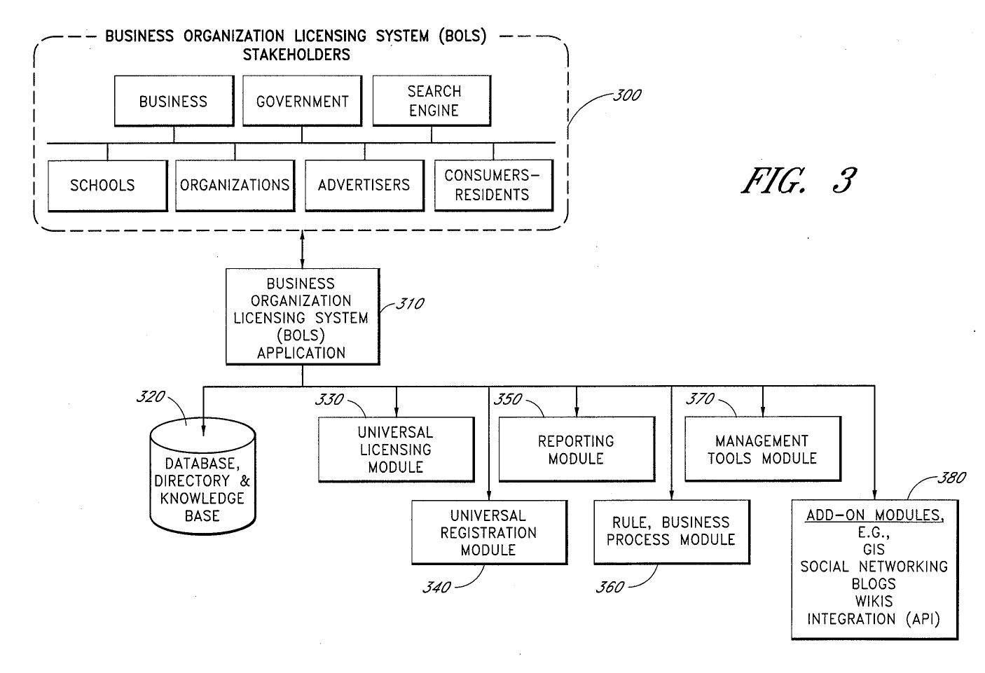

FIG. 2 illustrates a Business Organization Licensing System (“BOLS”) 200 which is a system and method to address and bring together the various stakeholders interacting in a city or local community of government 220, business 230, schools 240, civic organizations, clubs and associations 250, advertisers 260, consumers 270 and search engines (local and global centric) 280 through a set of rules, processes and knowledge captured in a database 210. While the present disclosure shows a particular use for U.S. and local government entities, the disclosed methods and systems also apply to any number of foreign government entities.

In some embodiments, the system and method of the present invention create a one-stop, online secured interface that lets a business complete certain types of activities and transaction(s) that are required in the course of operating a business. Various embodiments of the invention make it cheaper, faster, and easier to process a business license/permit and to compare, evaluate and purchase advertising to market and promote the business. Embodiments of the invention also provides an automated and streamlined process for businesses to create, organize, display and manage content they generate and to make the generated content more accessible and relevant. Embodiments of the invention create a platform whereby businesses with licenses can dynamically (input and have it made available immediately) contribute and share info and content collectively with residents and consumers, e.g., provide a centralized platform where useful information like “updated” hours of operation can be accessed in a uniform and consistent format for all licensed businesses. Embodiments of the invention also help generate sales, by creating an interactive, city government-centric platform that is specially organized and designed to attract local consumers/residents and reach targeted local audience. Embodiments of the invention also help businesses meet and comply with rules, codes, guidelines and regulations, by providing interactive, user-input driven content from BOLS knowledge base.

Furthermore, embodiments of the invention also facilitate access to new market opportunities and needed resources simply and easily by providing a one-click access to (e.g., pre-organized) option(s) such as, activities that lets a business automatically bid on local city contracts, be part of a welcome wagons vendor list and/or list openings for jobs, create a foundation anchored by business for creation of a virtual and real, across multiple cities, network that brings together different stakeholders in the local community that includes, but not limited to, local cities, clubs and organizations, advertising vendors, global and local search engines and consumers/residents. The result is creation of new uses, markets and income from the content generated, directly or indirectly, by the parties and their inter-relationships. (Creates new synergies and derives new relationships that currently do not exist.)

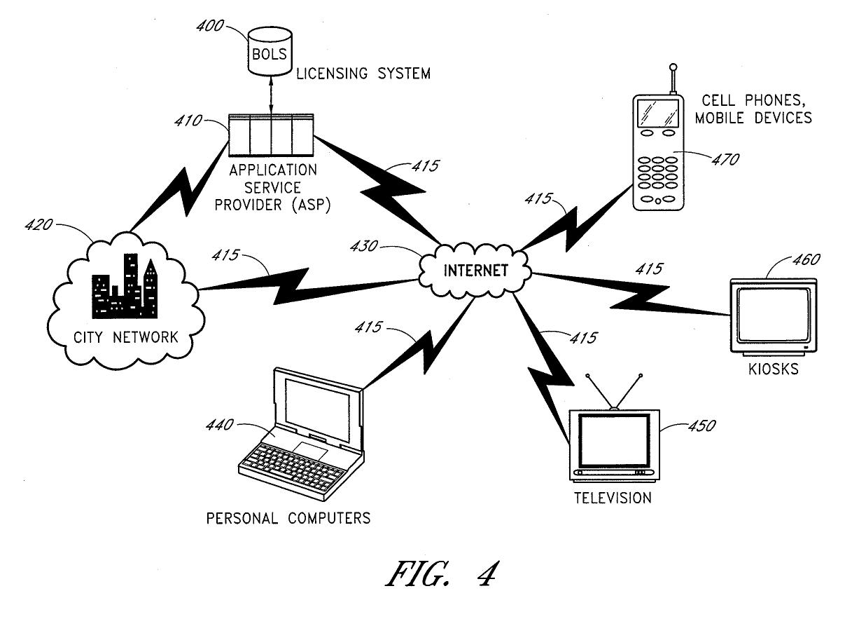

FIG. 3 is a diagram illustrating an embodiment of the BOLS application 310 for the community of stakeholders 300 comprised of business, government, search engines, schools, organizations, advertisers and consumers. The community of stakeholders 300 may register with BOLS via a Registration Module 340. Through the registration process, the various entities may access the modules specific to their needs and tailor their experience as necessary. Businesses can register for a business license in the communities where they will be providing or selling their goods and services to the local consumers through a licensing module 330.

The database, directory and knowledge base 320 is the repository that contains all the information provided from the BOLS universal licensing module 330, registration module 340, rules, business process module 360 and the add-on modules 380. The Reporting Module 350 provides ad hoc reporting capabilities of the database, directory and knowledge base. The user provides the reporting and selection criteria necessary to generate the requested report.

The Rules, Business Process Module 360 provides a collection of the methods, rules and processes for the user to apply on the website in order to initiate and implement a process specific to the user. The Management Tools Module 370 provides the capability to manage, customize, and setup various maintenance functions that include but is not limited to managing advertising directories, data field definitions, security, reporting preferences, forms, formula for distributions, etc. The Add-on Modules 380 provides additional capabilities that includes but is not limited to geographic information system (GIS), social networking, blogs, wikis and integration between other systems through an application program interface (API).

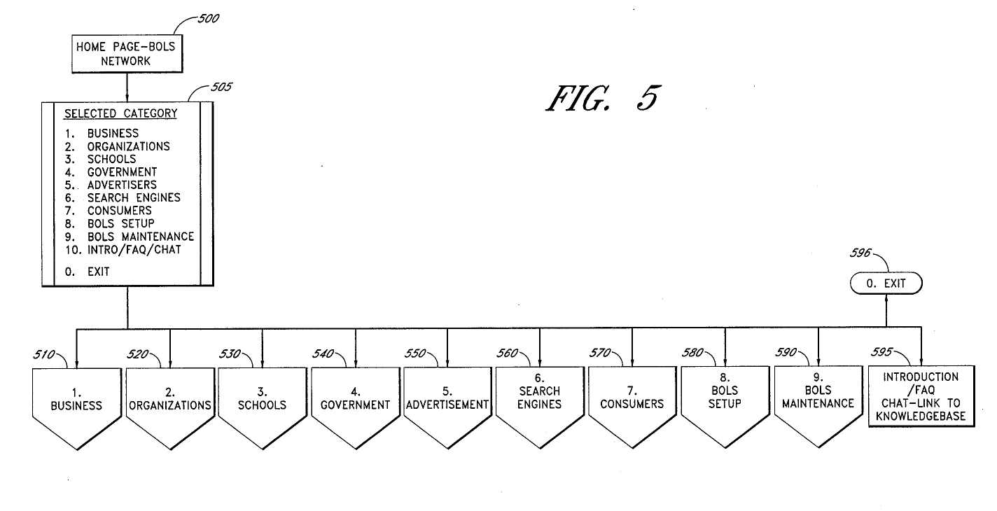

FIG. 4 depicts some communication systems commonly in use that may be accommodated in BOLS 400. BOLS 400 may be serviced through an Application Service Provider (ASP) 410 and connection occurs within the Internet 430. The Communication links 415 can be wired or wireless and can take the form of dial-up, DSL, cable modem, dedicated circuits (e.g., T1, T3, etc.), fiber, satellite, etc. BOLS 400 can then be accessed by a combination of devices and software confirmed to access the Internet 430 which can take the form of but is not limited to the following: cell phones and mobile devices 470, kiosks 460, personal computers 440, television 450 and others. For reasons of security and accessibility, government entities 420 may choose to connect directly to the ASP 410 via a direct network or opt to connect via the Internet 430. Because some government entities 420 have policies, rules or regulations that may prohibit against using the Internet to directly connect to an internal production system, government entities 420 can opt to access BOLS 400 hosted ASP 410 via a dedicated communications circuit 410, e.g., T-1 circuit, to the ASP. This method of access may prevent others from being able to access or intercept data from outside the internal government network.

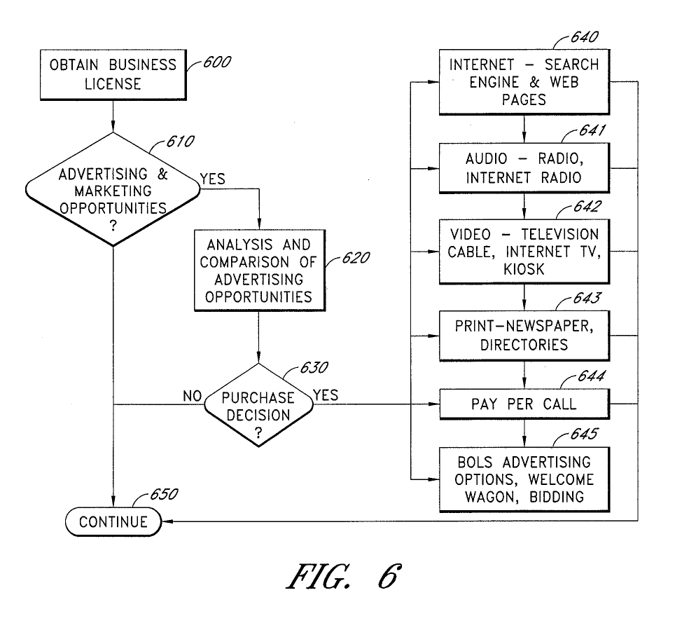

FIG. 5 is a block diagram of BOLS. BOLS users access the BOLS network 500 and are presented with a list of categories 505 to select from. For example, businesses select, via the home page 500, category 1, 510; organizations, clubs, associations select category 2, 520; schools select category 3, 530; government agencies select category 4, 540; and advertisers select category 5, 550 for further processing. BOLS setup is performed through selecting category 8, 580 and BOLS maintenance is performed through selecting category 9, 590. In some embodiments, features of managing and introduction, frequently asked questions (FAQ) and CHAT are performed by selecting the category box 595. Once completed, selecting category 0, 596 exits BOLS.

The licensing information that is available within the government agency databases can be very valuable to businesses, other government agencies, residents and consumers, search engine companies, and other parties that have need for this type of content. The licensing information can also be valuable within the government. For example, the comfort level and perception of security in buyers and consumers searching for information, or shopping online, are raised higher, if the business is identified as being “certified” by a third party to have an active business license in good standing from a government agency.

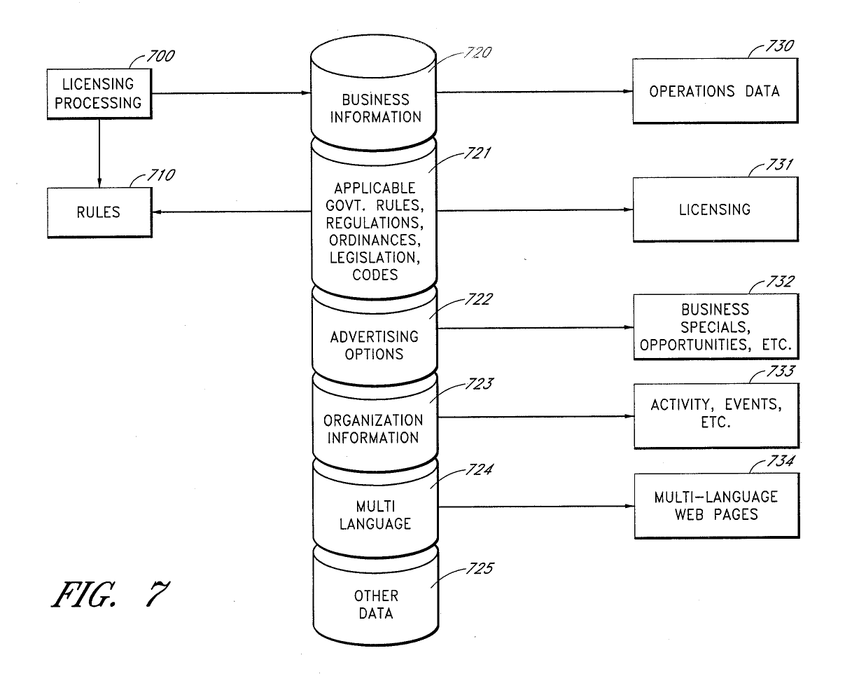

In some embodiments, the systems and method of the present invention introduce and offer advertising opportunities at the point-of-license. FIG. 6 is a block diagram of the advertising and marketing opportunities at the point-of-license. While applying for a business license 600, businesses are presented with the opportunity to purchase advertising and marketing options 610. If the business selects to continue, an analysis is performed providing a comparison of advertising opportunities 620. The business then makes the decision to purchase 630 the various advertising options or not. The various options for the business licensee to advertise are via the Internet 640, audio 641, video 642, print 643, pay per call 644, and BOLS advertising 645 such as “Welcome Wagon,” sponsorships, bidding, or other options. Any type of advertising option can be offered. Once completed, the process continues 650.

Embodiments of the invention facilitate access to marketing and advertising for new and renewing businesses. This way, BOLS may significantly reduce the cost for advertisers, such as phone books, newspapers, coupon vendors, radio and TV, immediate exposure to new businesses setting up shop and existing businesses at time of license renewal, offers a convenient place to complete advertising purchases. BOLS also reduces the cost for sales, customer service and self-marketing. By integrating with Global and Local (those that target local markets or specific audiences) Search Engines, the cities can help market and promote local business inside and outside the city and generate advertising revenues that can be shared with local government.

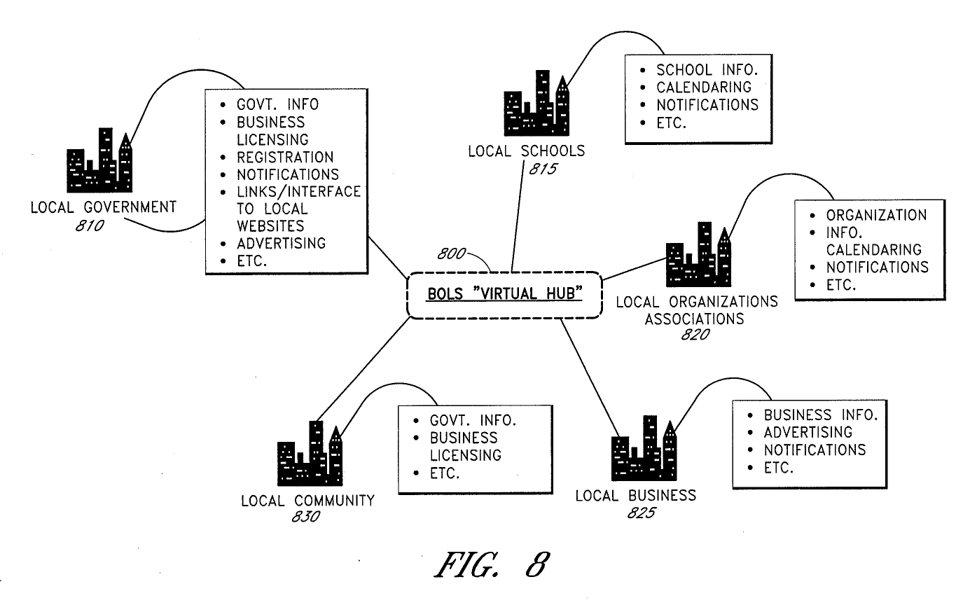

In some embodiments, the system and method of the present invention create a unique knowledge base including data, rules and integrated applications and “how” they are tied together. FIG. 7 is a block diagram illustrating the embodiments of BOLS licensing process 700 that creates a unique knowledge base and database that contains business information 720, applicable government rules, regulations, ordinances, legislation and codes 721, advertising options 722, organization information 723, multiple language data 724 and other information 725. The business information 720 data provides data on a business’ operation 730, e.g., operating hours, location, etc. that is useful to the community (consumer). The applicable government rules, regulations, ordinances, legislation and codes 721 of the BOLS database provides basis for determining the licensing 731 requirements of a business or organization as well as feeds into the Rules module 710 when determining if any additional requirements must be met, e.g., additional health requirements or fire requirements depending upon the type of business being operated. When a business opts for advertising 722, in addition to potentially numerous standard options, there are opportunities for advertising business specials 732 unique to the business. The organization information 723 data stored in the database provides organizations with the opportunity to provide, promote and maintain the activities and various events 733 that are offered to the community. The multiple language data 724 provides the opportunity to publish and translate English web pages into other languages that are more geared to that community's ethnic demographics, e.g., Spanish, Korean, etc.

In one embodiment, the invention provides information applicable to the type of business, such as for example a special permitted business like a massage parlor that needs to meet education requirements (certified training) and police requirements (finger printing). This is a different requirement than the requirement for a retail business that must comply with building code requirements. Businesses can manage business listing accuracy and also create content that is valuable to consumers via an on-line local based business directory on a city's website and linked to local websites such as the Chamber of Commerce, and business' own websites. For example, hours of operation are useful to local residents.

Moreover, a city can leverage BOLS to distribute information about and encourage participation in local community events. For example, Park and Recreation departments often coordinate community events, but lack the resources to encourage participation or to promote the events. BOLS provides such resources cost effectively.

In some embodiments, the invention provides in-process link and transactions. For example, when a business takes out a new business license or permit, it may want to establish a fictitious business name. During the completion of the online application BOLS can provide an immediate link to a third-party recording processor or directly to a county to record the name and at the same time a link to a local newspaper to complete a transaction that would allow the fictional name to be advertised (according to law) all in the same license application transaction.

In some embodiments, the invention provides a user account to businesses to easily manage and update information distributed to consumers and other stakeholders. The knowledge base created in the process of licensing the businesses through BOLS creates valuable content for other businesses. For example, a specialized database of content from business licensees can be created that provides products and services specifically for the purpose of business-to-business (B2B) for a targeted business audience, e.g., list of all products and services from existing local businesses available to new businesses. BOLS aggregates all the data and information about the business and confirms that the businesses are licensed. This aggregated and up-to-date information can then be used by specialty websites or search engines that seek and provide “local info” such as Google™, Yahoo™, and MSN™.

In some embodiments, the invention helps non-English speaking businesses communicate and interact more effectively with government agencies when seeking information as well as encourages them in the process to comply with regulations. In some embodiment, the invention takes all the English content and translates it into the selected language using the Language Translator Module to provide appropriate content, info and response. Stored in the Language Translator are all the corresponding English equivalents (responses, phrases, category descriptions, rules, regulations and codes for selected languages). The initial translations stored in the translation database use machine translations combined with review by human editors to ensure complete and accurate translation. For example, translations for all the business categories (i.e. the description category for accountant or restaurant can be in Chinese, Spanish, French, Italian and so forth) that are used in the online Business Directory for native language access are stored in the database. This same category description can be used in the print-out of the license application. Another example would be an introduction video in a non-English native language welcoming a new business to the community accessed at the point-of-license. This provides government agencies with an effective means of communication wherein English is not the primary language.

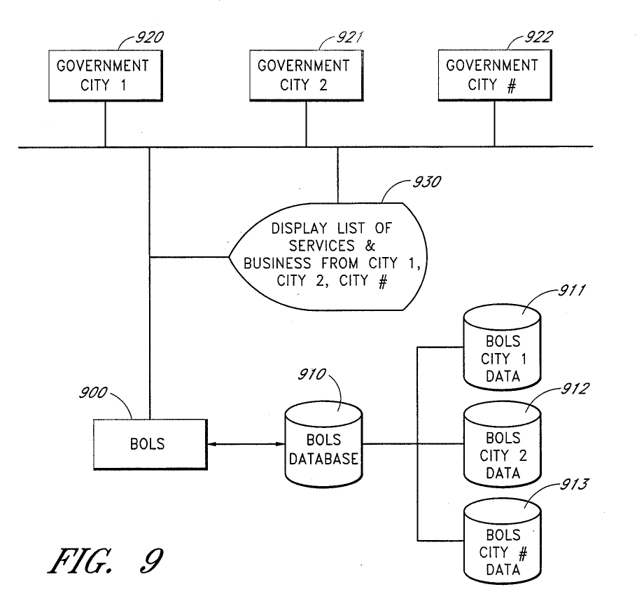

In some embodiments, the invention creates a “virtual hub” for integration, for example, building unique relations that otherwise may not occur around a government based catalyst, of a local community (city in the real world) with its own unique content and population. FIG. 8 is a diagram illustrating that BOLS creates a “virtual hub” 800 that connects together local government 810, local businesses 825, local organizations and associations 820, local schools 815, and the local community 830. Thus, BOLS may provide integration of local community content such as but not limited to, information related to government, schools, organizations, businesses and chamber, local communities, advertising, calendaring, events and activities, registration, notifications and links/interfaces to other websites.

The invention brings together a local community by allowing local clubs and associations (churches, clubs, non-profits) to register directly with the city and expose themselves to the business and consumer networks at the same time. Thus, the related data is entered and managed by clubs and other registrants, which improves accuracy and self-organization within a government based platform. The method and system of the invention allows organizations to post info such as membership information, monthly calendars, etc. This information is then exposed to the businesses and consumers encouraging easy access and participation. Communities benefit from the strength of participation.

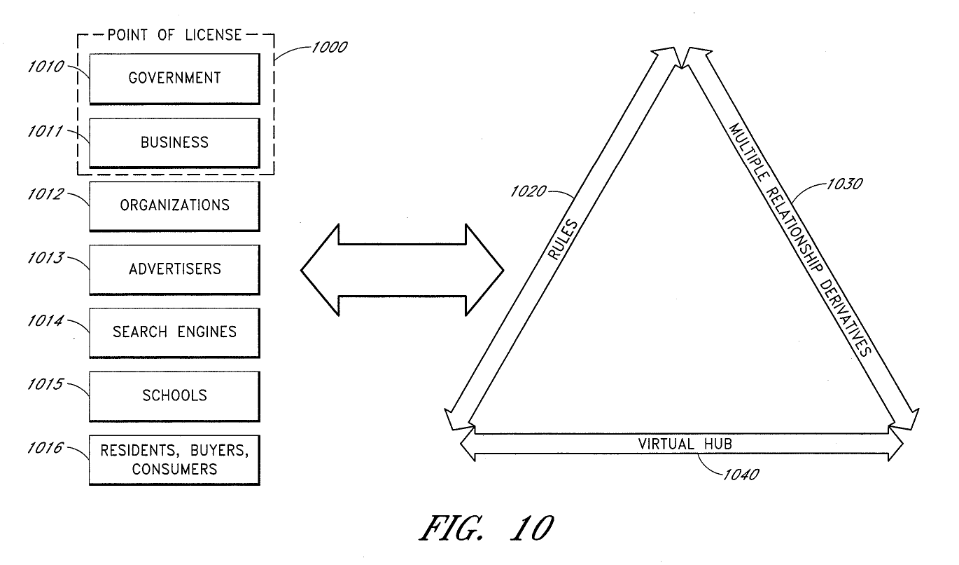

In some embodiments, the invention networks content for multiple cities creating added value from the convenience and broad-based scope of obtaining information. FIG. 9 is a diagram illustrating BOLS 900 availability of data from multiple government entities 920, 921, 922. Information and data related to licensing may already exist within government entities 920, 921, 922. This may take the form of electronic data stored on text documents, spreadsheets, databases, existing applications and/or hard copies. The government entities input the necessary data into BOLS 900 and the BOLS database 910 stores this data and information. BOLS database 910, for example, is queried to display a list of services and businesses 930 that are within and near the local communities that are served by the various government entities (cities). For example, a consumer that lives in one city can have access to information for all the available licensed plumbers in one area (versus just in the city the consumer resides); in contrast, typically all the plumbers found in the phonebook for an area may not be properly licensed to do business in a particular city even though they may service the area. The system and method of networking and having the information centralized across multiple cities provided by the invention addresses the issue of not having all desirable information about local businesses in one place in one usable format.

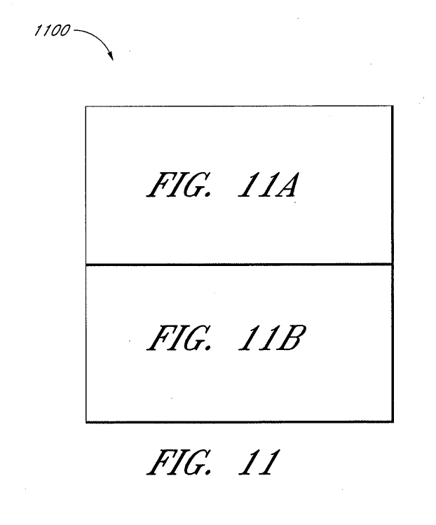

FIG. 10 is a diagram depicting the relationship between BOLS 1020, 1030 and 1040 and stakeholders (1010-1016). In some embodiments, the system and method of the present invention creates a unique database of knowledge, data including rules and information 1020; creates and derives multiple relationships and relationship derivatives among the stakeholders (1010-1016); and creates a “virtual hub” 1040 for integration and facilitating the interaction or the relationships of the stakeholders. Relationships may be created from value-added information, content, uses, applications or benefits derived from combinations of information collected from stakeholders (1010-1016) by BOLS. In some embodiments, the system and method of the present invention builds unique relations that would otherwise not have occurred around a catalyst creating a “Point-of-license” 1000 between Government 1010 and Business 1011 of a local community.

In one embodiment, the system and method of the present invention generates many levels of uses and benefits for many levels of stakeholders. FIG. 10 shows how the BOLS process produces many levels of value-added content, interaction, applications and benefits. For example, this invention can be applied to the activity of promoting, marketing, advertising and selling a pizza. The process starts at the point-of-license 1000. A pizzeria (Business 1011) files a license with a city (Government 1010). Information or data is provided by the pizzeria during the licensing process and with the information the invention then begins the processes based on the rules and data made available in the database 1020. The pizzeria can then be listed on the online directory on the government 101 website. The online information is now available and accessed and used by local residents 1016, organizations 1012, other businesses 1011, or schools 1015 to order or dine at the pizzeria. If the pizzeria had a need to expand its level of advertising and promotion it could elect to do so via access to local advertising vendors 1013 and search engines 1015 at the point-of-license 1000.

As a result of the initial licensing process, multiple relationships are derived 1030 between the various stakeholders and the invention provides the connection via its database and rules 1020 and interaction occurs at the virtual hub 1040 through accessing BOLS.

BOLS Stakeholders 300 can initiate a value added application through the virtual hub 1040. Organizations 1012 and schools 1015 order pizzas for fundraisers and then use BOLS to announce and promote such events via the government 1010 website—this organization-school-government relationship is derived and enabled through the virtual hub 1040.

If the pizzeria is located at the borderline of the city boundaries, it will find its service area limited if it promotes itself only to an audience within the city in which it is located. BOLS addresses this by taking the collected data and making the information accessible across multiple cities. Additionally, BOLS can process and reorganize the information in the aforementioned organization-school-government value added fundraising application and enable the content to be distributed across multiple cities, providing multiple links to search engines and targeting additional audiences within different venues through its Multiple Relationship Derivatives 1030. Multiple Relationship Derivatives are relationships derived from one or more other relationships.

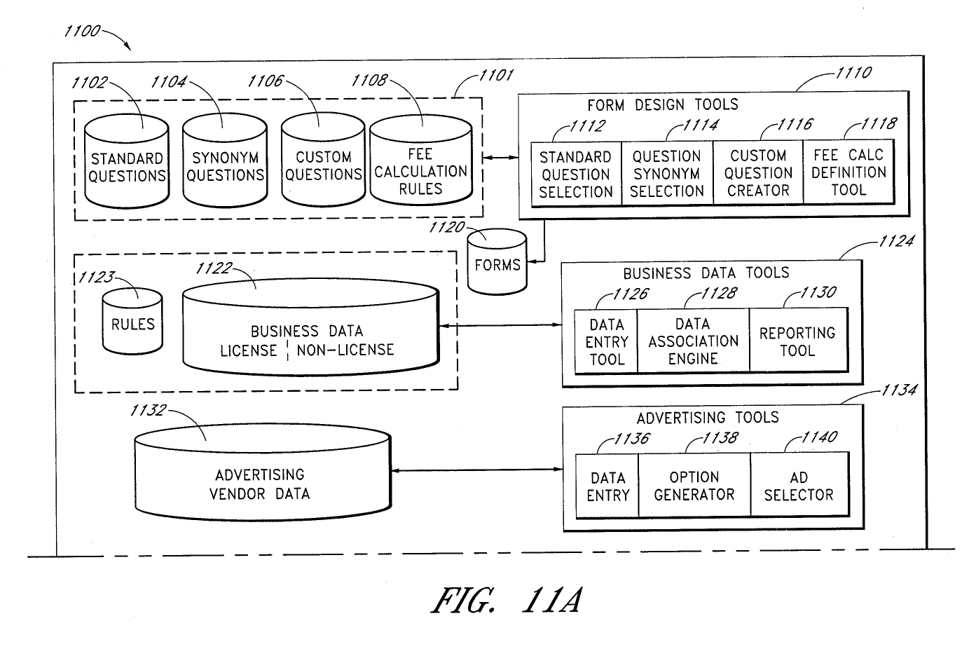

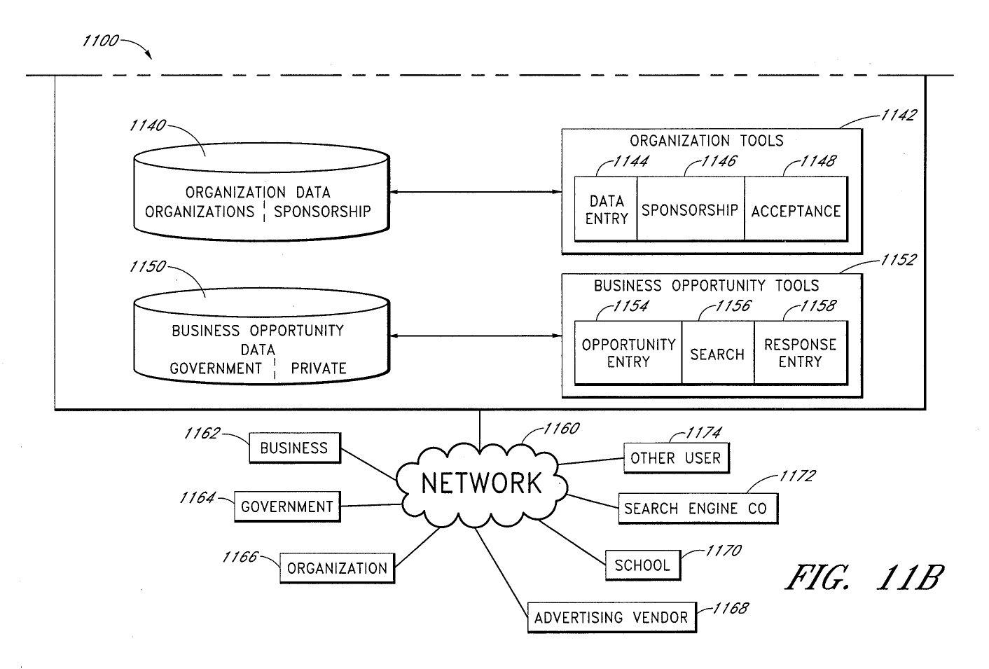

FIG. 11 is a block diagram depicting one embodiment of a point-of-license business data collection system in accordance with the present invention. As illustrated, a point-of-license business data collections system 1100 may comprise form generation databases 1101, a form database 1120, a business database 1122, a rules database 1123, an advertising vendor database 1132, an organization database 1140, a business opportunity database 1150, form design tools 1110, business data tools 1124, advertising tools 1134, organization tools 1142, and offer tools 1152. Each of the foregoing components is optional in that embodiments of the system 1100 may have only a subset of the foregoing components. In addition, the system 1100 may have all or a subset of the foregoing components combined with other components not illustrated in FIG. 11 but which would be appreciated by a skilled artisan in light of this disclosure.

As illustrated, the system 1100 may be connected with a network 1160 such as the Internet. The network 1160 may, in turn, be connected with any number of computers or other devices operated by businesses 1162, governments 1164, organizations 1166, advertising vendors 1168, schools 1170, search engine companies 1172, or other users 1174. Advantageously, connecting the system 1100 to the network 1160 allows a large number of businesses, organizations, government entities, and individual users to access the databases and tools available on the system 1100. By way of example and not limitation, users can access the system 1100 through the network 1160 and perform one or more of the following tasks: design licensing forms, enter business data, search for local (or non-local) businesses that have information stored in the business database 1122, sell and purchase advertising opportunities available through the system 1100, enter organization data, sponsor organizations, enter or search for information about offers (such as bids, job offers, etc.) available to users of the system 1100, or perform any of the other functions available through the system 1100.

One advantageous embodiment of the system 1100 provides powerful tools to allow towns and cities to design electronic forms for collecting business licensing information. As illustrated, the form generation databases 1101 and form design tools 1110 may interact with each other to provide this form design functionality. In one embodiment, the form generation databases 1101 include a standard questions database 1102, a synonym questions database 1104, a custom questions database 1106, and a fee calculation rules database 1108. The standard questions database 1102 stores standard data fields that are commonly included on city licensing forms. Examples of standard questions include whether a business does business inside a city or outside a city, how many employees a business has, what industry the business is in, the address of the business, the owner of the business, and the like. The “questions” may but do not have to be phrased in the form of a question. Thus, for example, a “question” may be a short phrase such as “No. of Employees” that invites a user to enter the number of employees that the business has.

In this application we often use the term “city” or similar terms for various government units. However, the invention is not limited to use by a city. Rather, as will be apparent to a skilled artisan, any government unit, including a town, county, state, hospital district, library district, water district, or any other government or controlling or supervisory entity can use the embodiments disclosed herein. Accordingly, a skilled artisan will understand that all examples that refer to the use by a “city” can apply equally to the use by a town, county, or any other government entity.

Preferably, the standard questions database 1102 includes the more commonly-used phrasings for standard questions. The standard questions database 1102 may be created using human data entry, automated processes, or any combination of the two. For example, a person may obtain a large number of business licensing forms from many cities, research which questions are commonly-used, and enter the commonly-used questions into the standard questions database 1102. Alternatively, paper forms may be scanned and an automated process using optical character recognition or the like may identify the questions on the forms, determine which questions are commonly-used, and enter the commonly-used questions into the standard questions database 1102. Alternatively, an automated process such as a spider may search through electronic forms available on the Internet, determine which questions are commonly-used, and enter the commonly-used questions into the standard questions database 1102. Alternatively, a combination of human and automated input may be used to build the standard questions database 1102. For example, a person may enter into a database the questions that each city uses and an automated process may run one or more queries on the database to determine which questions are commonly-used, and then store the commonly-used questions in the standard questions database 1102.

In one advantageous embodiment, as cities design new forms that are stored in the form database 1120, the system 1100 keeps track of which questions are commonly-used in those forms and periodically updates the standard questions database 1102. For example, if numerous cities design forms that include a question about average annual profit, the average annual profit question may be added to the standard questions database 1102. On the other hand, if cities stop asking for certain information, such as average annual profit, the system 1100 may detect that the average annual profit question no longer appears on very many forms in the form database 1120, and the system 1100 may remove the question from the standard questions database 1102. Preferably, the standard questions database 1102 has sufficient questions to allow a user to easily select most of the questions that likely are needed in designing a new electronic form for a city, for licensing or otherwise.

The synonym questions database 1104 stores alternative phrasings for standard questions. For example, if one of the standard questions stored in the standard questions database 1102 is “Zip Code,” one of the synonyms stored in the synonym questions database 1104 may be “Postal Code.” Preferably, the synonym questions database 1104 stores sufficient synonym questions to allow a user to easily select a synonym question that precisely matches the phrasing that the city uses for its forms. Advantageously, each synonym question may be correlated to a standard question so that the system 1100 can compare similar data or generate demographics or trend reports even when different cities use different phrasing for the same underlying data. For example, correlating synonym questions with standard questions allows the system 1100 to treat the “postal code” field and the “zip code” field as equivalent in the United States so that a search for businesses within a “zip code” will work even if a city's licensing data includes “postal code” information rather than “zip code” information.

In one embodiment, the custom questions database 1106 stores questions that have been entered by users. In some cases, a city may want to design a form that includes a question that is so rarely asked that it is not in the standard questions database 1102 or the synonym questions database 1104. Accordingly, in some embodiments the system 1100 allows users to enter custom questions that are stored in the custom questions database 1106. Periodically, the system 1100 may search the custom questions database 1106, either automatically or with some level of human interaction, to determine if any custom questions have become commonly-used such that they should be added to the standard questions database 1102.

The fee calculation rules database 1108 encodes rules for calculating fees. Advantageously, standard pre-defined fee calculation rules are provided that a user can select from and combine to create fee calculation logic for calculating fees at the point-of-license. The system 1100 may store pre-defined fee calculation rules associated with different business classifications or other business characteristics. Advantageously, associating the pre-defined fee calculation rules with business classifications or business characteristics allows the system 1100 to present different default fee calculation rules depending on the classification or characteristics of a particular business.

The form in database 1120 stores forms that have been entered into the system 1100.

In one embodiment, the form design tools 1110 comprise a standard question selector 1112, a synonym question selector 1114, a custom question creator 1116, and a fee calculation definition tool 1118. The standard question selector 1112 is configured to allow a user to select one or more questions stored in the standard questions database 1102 and add the selected questions to a user-designed form. The standard question selector 1112 may be implemented as a pull-down menu, a pop-up menu, a pick list, or any other mechanism for selecting items.

The synonym question selector 1114 is configured to allow a user to select question synonyms stored in the synonym questions database 1104 and add the selected questions to a user-designed form. The synonym question selector 1114 may be implemented as a pull-down menu, a pop-up menu, a pick list, or any other mechanism for selecting items. Preferably, the synonym question selector 1114 may be accessed by a user during the process of selecting standard questions. For example, a user may highlight or otherwise select the “zip code” question and invoke the synonym question selector 1114 to be presented with a list of synonyms, such as “postal code,” for the “zip code” question.

The custom question creator 1116 is configured to allow a user to enter a custom question and add the question to a user-designed form. Additionally, the system 1100 may also have a custom question selector (not shown) that allows a user to select a custom question that was previously-stored in the custom questions database 1106 by a different user or the same user. The custom question selector may function in the same manner as the standard question selector 1112 and synonym question selector 1114. Advantageously, by allowing for the creation or selection of custom questions, the system 1100 allows users to add questions to forms that were not deemed to be commonly-used enough to be included in the standard questions database 1102 or synonym questions database 1104.

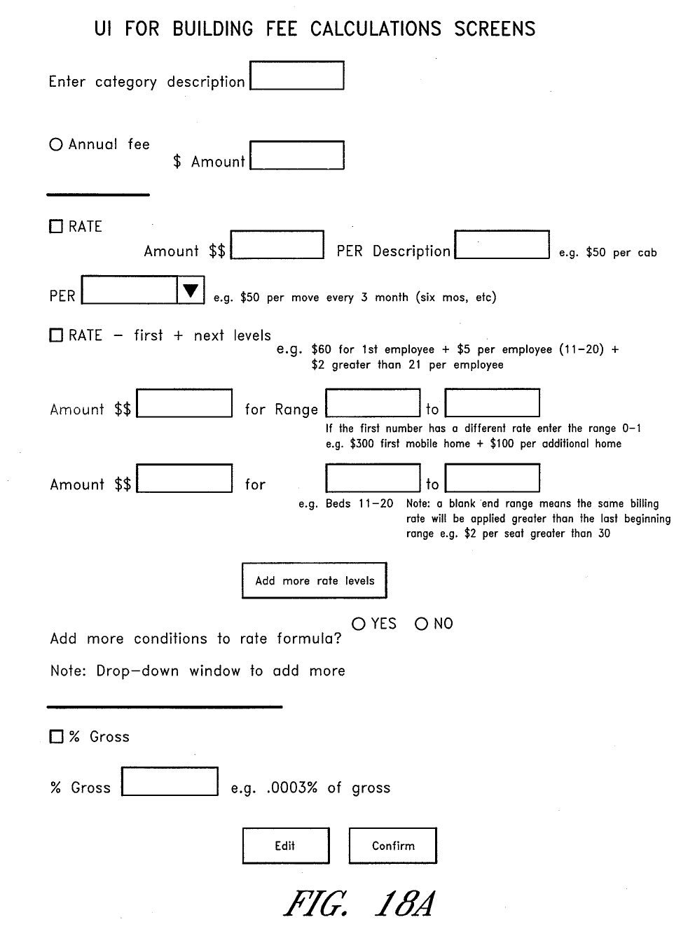

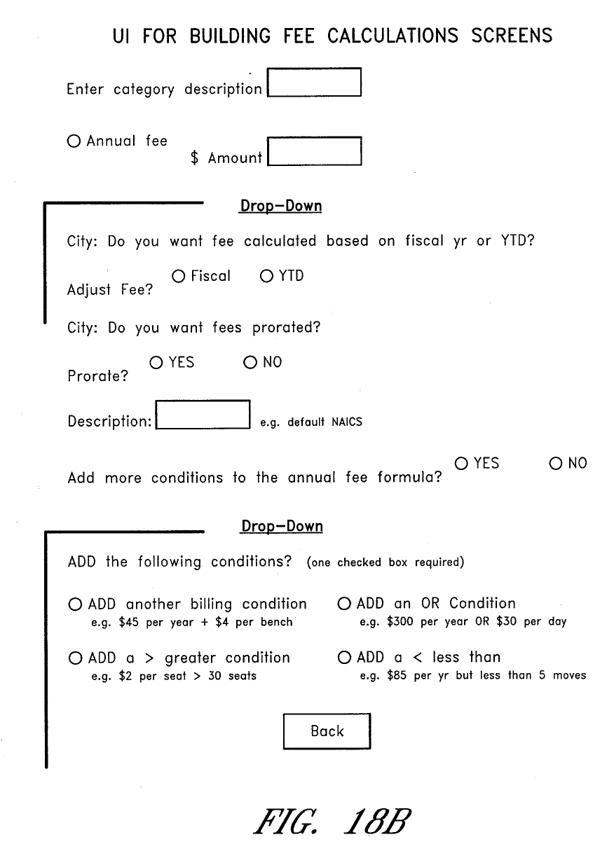

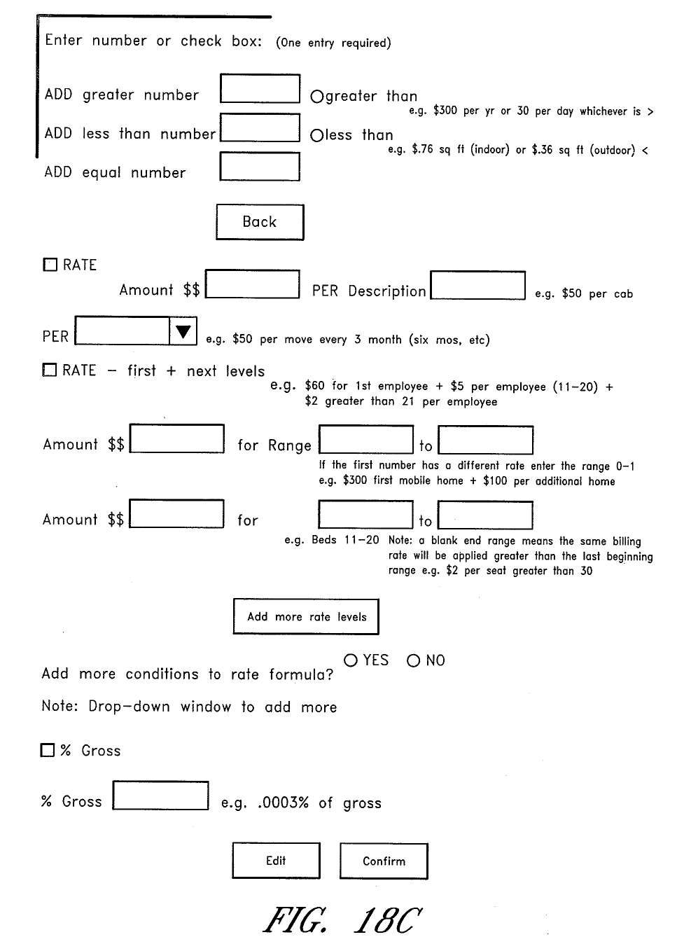

The fee calculation definition tool 1118 is configured to allow a user with no programming skills to easily build fee calculation logic. In one embodiment, the fee calculation definition tool 1118 allows a user to select and combine various fee calculation rules from the fee calculation rules database 1108 in order to create fee calculation logic that is associated with a user-designed form. In essence, the fee calculation rules serve as building blocks that each represent a component of a fee calculation. For example, one fee building block may allow a user to define a flat fee (e.g. every business has to pay $200 to be licensed). Another fee building block may allow a user to define a fee based on a number of particular items operated by a business (e.g. a business has to pay $10 for every vehicle operated within the city). Another fee building block may allow a user to define a variable fee based on a number of particular items operated by a business (e.g. a business has to pay $50 for the first vehicle it operates within the city and $10 for each additional vehicle operated within the city). Yet another fee building block may allow a user to define a percentage-based fee (e.g. a business may have to pay a small percentage of its income to the city). FIGS. 18A, 18B, and 18C illustrate a user-entry form that includes several other examples of fee calculation rules or building blocks that are used to define fee calculations associated with a form.

As indicated, users use the form design tools 1110 to design electronic forms that towns and cities use for collecting information about businesses during the process of licensing the businesses. In one embodiment, data defining the user-designed forms are stored in the form database 1120. When a user accesses the system 1100 to enter information during the licensing process, the system 1100 looks up the appropriate form data from the form database 1120 and presents the appropriate information (e.g. the information that the city wants to collect) to the user.

Preferably, the form design tools 1110 are configured to allow a city to generate multiple forms. Cities commonly require different forms for different types of businesses, or require certain businesses to obtain additional licenses that are not commonly required. For example, bars and restaurants that serve alcohol may be required to obtain a license to serve alcohol and may be required to provide additional information in order to obtain the license. Preferably, the form design tools 1110 allow a user to specify rules and conditions for determining which businesses are required to fill out which forms. For example, one rule may specify that all businesses must fill out a form for a general business license while another rule may specify that bars must fill out a form for a license to serve alcohol. Preferably, such rules and conditions can be tied to various categorization systems for businesses, including, for example, the North American Industry Classification System (“NAICS”) and Standard Industrial Classification (“SIC”) classification systems. Thus, for example, if a business has a classification of a type of business that serves alcohol, the business may be required to fill out a form for a license to serve alcohol.

We refer in this application to several features of the system 1100 and the various processes that use the type of business that a business carries out as a factor in how the features operate. For example, advertising opportunities may be determined at least in part by a business' type. In such cases, the system 1100 preferably uses a specific business classification system such as the NAICS, the SIC, or any other classification system. The system 1100 may also provide a hierarchical selection tool that assists a user to select a proper classification by iteratively narrowing down classification choices.

Advantageously, by allowing cities to define multiple licenses, the system 1100 enables businesses to enter license information for multiple licenses in a single system, saving time and effort for the businesses. Moreover, business compliance in obtaining the appropriate licenses will likely increase with the use of the system 1100 because of the convenience of the system and because businesses will be more aware of the licenses that are required. Preferably, the system 1100 determines, based on classification information for a business, which licenses the business may need, and displays a notice and the opportunity for the business to fill out each required form.

When a form has been defined by a city, the system 1100 allows businesses to enter the information that is required for the form. In this way, the system 1100 helps cities obtain business data. In one embodiment, the business data entered by a business is stored in the business database 1122. In one embodiment, business data tools 1124 are provided to allow a user associated with a business to enter the business data. The illustrated business data tools 1124 include a data entry tool 1126, a data association tool 1128, and a reporting tool 1130.

The data entry tool 1126 is configured to allow a user to enter information into a form. The data entry tool 1126 refers to the form database 1120 in order to determine which information is required for a particular form. Upon entry of the information, the data entry tool 1126 stores the collected business data in the business database 1122. Preferably, the data entry tool 1126 provides an interface that a user can access from a remote computer on a network. Alternatively or additionally, data entry tool 1126 may be accessible using a kiosk. For example, a kiosk with access to the data entry tool 1126 may be located in a government office in order to allow walk-in users to enter information. Alternatively or additionally, the data entry tool 1126 may be accessible on the same computer that has the business database 1122.

Preferably, as shown in the illustrated embodiment, the business database 1122 comprises both license business data and non-license business data. In this application, we use the phrase “non-license business data” to refer to business data that the city does not require as part of the licensing process but is additional information that is useful for classifying businesses and providing searchable information about businesses to consumers. We use the phrase “license business data” to refer to business data that the city does require as part of the licensing process. Examples of non-license business data include hours of operation, inventory of products for sale, pricing information, and the like. In one embodiment, the non-license business data that is to be collected is specified in the form database 1120 along with the license business data. Alternatively or additionally, some or all of the non-license business data may be specified in a separate database or simply hard-coded into a software module configured to collect the information.

Preferably, the license business data and the non-license business data is sufficient to allow the system 1100 to automatically generate a search engine that is particularly adapted for searching of businesses within a specific geographic area. In one embodiment, the data is particularly adapted to automatically generate a search engine that includes business information for licensed businesses within a particular city. Alternatively or additionally, the data may be particularly adapted for the automatic generation of a search engine that includes business information for licensed businesses within a particular town, county, state, region, neighborhood, borough, ward, precinct, block, building, zip code, or any other geographical subdivision. Alternatively or additionally, the data may be particularly adapted for the automatic generation of a search engine that includes business information for businesses within a user-defined geographic area, such as, an area located within a given radius of an address, or an area defined by a graphical box (or other shape) that a user electronically draws on a map.

Alternatively or additionally, the user can search based on a large number of other data fields besides geographically-based fields. For example, a user can search for businesses open after midnight, businesses that are restaurants, businesses that accept credit cards for payment, businesses that were first licensed within a certain period of time, and the like.

It is advantageous to collect non-license data in addition to license data because license data typically does not provide sufficient information for creating a comprehensive search engine for a defined geographic area. For example, city license information is often not accessible online, and any information that is available online is typically not useful for ordinary consumers who desire to locate a business with whom the consumers may want to do business. Accordingly, city license information may be useful to the city to administer its rules and regulations but may not be useful to private consumers. The collection of non-license business data to supplement license business data overcomes the shortcomings of systems that collect only licensing business data. By supplementing the license business data with non-license business data, the system 1100 is able to create comprehensive search engines for defined geographic areas.

In one embodiment, the data association tool 1128 is configured to create the search engines in the manner set forth above. Creating the search engines may include organizing data in a format particularly suited for fast access and retrieval, indexing data, determining additional associations between data items that may not be immediately apparent, and the like. Determining additional associations may include the use of data mining techniques and tools that are understood by a skilled artisan. In addition, the data association tool 1128 may calculate aggregate information such as demographic information and statistical information that may be used to create reports about aggregate data. Such aggregate information is advantageously useful for a consumer to find out information about an industry within a geographic region, such as, for example, the number and size of manufacturing businesses within a region. Preferably, historical aggregate information may be calculated or stored by the system 1100 such that the data association tool 1128 may also be used to discover and analyze trends. For example, historical aggregate information may be compared across different timeframes to determine whether the manufacturing sector is growing or declining in a particular region. Advantageously, this ability to discover and analyze trends may be used to help identify shifting trends in products and services that are being offered in a particular area.

In one embodiment, the data association tool 1128 uses rules stored in the rules database 1123 to help make associations between data items and thus to assist in generating powerful search engines for the business data. For example, a rule in the rules database 1123 may indicate that certain businesses are related to other businesses based on their respective classifications. For example, one rule may indicate that contractors are related to concrete companies in that contractors often hire concrete companies to mix concrete and to deliver the concrete to a job site. Accordingly, the rules database 1123 helps the data association tool 1128 to derive a web of relationships that exist between businesses in a local geographic area. Preferably, rules in the rules database 1123 that relate to type of business are able to finely distinguish among different business types, such as by using a classification system such as the NAICS or the SIC.

In one embodiment, the system 1100 includes a multi-language engine (not shown) configured to assist a city to reach different audiences based on language and culture. The multi-language engine includes translation of forms and instructions into several languages to aid communication with people with different languages and cultures. Moreover, the rules database 1123 may also have different rules depending on language and culture.

Advantageously, the system 1100 has the ability not only to record information captured at the point-of-license, but to organize the information into searchable data that can help users research businesses. Collecting the information at the point-of-license increases both the quality and the quantity of information that can be accessed by the resulting search engines. Point-of-license collection increases the quality of the information because businesses are inclined to be accurate during the business license application process. Moreover, the information is likely to be timely and current because businesses generally must periodically update their licensing information. Additionally, the information collected is more complete than information collected by existing systems. Point-of-license collection increases the quantity of the information because the business' attention is focused on entering business information during the process of applying for a business license. Accordingly, if additional information is requested during this time, the business is more likely than at other times to provide the information. As such, collecting business data at the point-of-license assists the system 1100 to generate a comprehensive data set and search engine.

Preferably, upon generating a search engine for a city, the system 1100, or a service provider that operates the system 1100, makes the search engine accessible from the city's website. The data and functionality of the search engine may be installed on the city's web server or the city's website may be programmed to pass search parameters to a remote computer that hosts the data and functionality of the search engine. In an embodiment in which the search parameters are passed to a remote computer, the remote computer executes a search query based on the search parameters, obtains results, and transmits the results to the requesting web server for display. Advantageously, making the search engine accessible on city websites allows cities to offer a powerful search engine having information about local businesses without having to maintain the hardware, data, or code needed to operate the search engine.

The business data may also be made accessible by a general search engine that is not limited to any particular city or region. A service provider that maintains the system 1100 may host such a general search engine on a web server accessible via the Internet at a particular web address. For example, in one embodiment, a general search engine is provided at the web address www.e2g2.com. Alternatively or additionally, the search engine may be made accessible from other websites, including sites such as Yahoo!, Google, MSN, or the like. Advantageously, a search engine may allow a consumer to search for business information in any city, zip code, state, or other geographic area. For example, a consumer may enter a search for car dealers within the 92604 zip code. Advantageously, the general search engine may return results that are within a certain distance from a location but that are not necessarily confined to a single city or other geographic unit. For example, a consumer may enter a search for restaurants within 5 miles of an address and may receive results of restaurants in cities that border the city in which the address is located.

As indicated above, the data association tool 1128 associates the business data in order to create searchable business data for a search engine that may be geographically-focused. Although the search engine may be geographically focused, it also allows a user to search on many other data fields that may or may not be geographical, such as, for example, hours of operation, acceptance of credit cards, business classification, and the like. Moreover, because businesses are precisely classified and organizations are registered in detail, the search engine may also provide powerful tools for grouping search results in accordance with the many data fields and classifications of data. Thus, searches may be performed that are not just geographical searches, but also searches that group results based on one or more descriptive criteria such as business type, product or service, and many, many others.

The reporting tool 1130 is configured to display the business data in many useful forms. For example, the reporting tool 1130 may display a list of restaurants within a 1 mile radius of a particular address, thus assisting a business traveler in finding a restaurant close to his or her hotel. Other example reports that may be generated by the reporting tool 1130 include demographic reports, statistical reports, reports of local businesses that are open at a given time (e.g. a report showing automobile repair shops that are open at odd times), reports of businesses that sell a given item (and perhaps the price at which the item is sold), reports of job openings at businesses of a particular type and within a 50 mile radius of a person's home, and the like.

Preferably, the reporting tool 1130 may be used to generate reports in many different formats. For example, in one embodiment, the reporting tool 1130 generates a list of “hits” that are displayed on a webpage or in another electronic format. This embodiment is essentially a report generated by a search engine. The reporting tool 1130 may also be used to generate print or electronic directories. For example, the reporting tool 1130 may query the business database 1122 and automatically generate a business phone book (e.g. “yellow pages”) for a city. The business phone book may be formatted as an online phone directory displayed on a webpage, printed to a print directory, saved to a CD as an electronic directory, or any other format understood by a skilled artisan. In addition, the reporting tool 1130 may be configured to generate more specialized directories, such as a directory of intellectual property law firms within a state.

The system 1100 may be used by a service provider to collect license information for a city or other government unit. Advantageously, the service provider may provide any computers or other equipment needed to run the system 1100, thus saving the city money. One or more users associated with the city use the form design tools 1110 to design the forms and enter the information that the city requires for licensing a business. The service provider then provides computers for hosting the forms and for storing information entered into the forms by businesses. In addition, the service provider provides mechanisms for businesses to enter information into the forms. In one embodiment, the service provider hosts an online service that businesses can access over a network to enter their information. Alternatively or additionally, the service provider may provide kiosks at various locations. Alternatively or additionally, the city either provides its own resources for hosting the data or receiving information from businesses or the city provides some of the resources while the service provider also provides some of the resources.

Preferably, the service provider makes the licensing data that it collects available to the city or other government unit for which the service provider operates. Advantageously, the service provider may make the licensing data available to the city in various formats, including electronically, in hard copy printouts or directories, or in other formats requested by the city. Optionally, the service provider may format the data into a format that is compatible with other city computer systems. For example, the service provider may create electronic files containing all or part of the licensing data that are compatible with city software that manages property tax information. Alternatively, the service provider may incorporate the functions of such software into the system 1100.

In some cases, government units may request sensitive information from businesses that is not meant to be publicly-accessible. Thus, the system 1100 includes security data that indicates which license business data should not be publicly-accessible and which license business data can be publicly-accessible. The system 1100 is configured to check the security data and to prevent the display of information that is not meant to be publicly-accessible. Accordingly, while the system 1100 provides a powerful tool to automatically generate search engines for use by the public, it does not incorporate or display private or sensitive information into the search engine results. For example, the system 1100 prevents the display to the public of taxpayer identification numbers, social security numbers, bank account numbers, and other sensitive information. Preferably, the system 1100 does allow authorized persons (such as appropriate persons within government agencies) to view some or all of such sensitive information, and the system 1100 includes user-by-user security information that determines who can access which information. Preferably, different security permissions may be set for each type of information.

Optionally, the system 1100 may be configured to use certain sensitive information, such as financial data, to generate aggregated demographic reports that do not identify individual businesses. Such reports may be useful to the public for understanding the economy of a particular region or industry, for spotting demographic trends, or the like.

In addition to collecting business data, the system 1100 may also provide value-added services such as advertising services, a service to coordinate sponsorship of community organizations or schools, a service to process information about bids and offers (e.g. distributing information about bidding for government contracts or information about job offers), a “welcome wagon” service, and other services. Preferably, the system 1100 makes such value-added services available to businesses at the point-of-license. Making such services available at the point-of-license provides a good opportunity to target businesses that are the natural consumers for the value-added services.

In one embodiment the system 1100 allows advertising vendors the opportunity to sell advertising to businesses at the point-of-license. In one embodiment, the system 1100 includes an advertising vendor database 1132 that includes relevant information about advertising vendors, including the type of advertising available (e.g. print, Internet, cable TV, radio, and the like), pricing, circulation or viewership information, geographical coverage, and the like. Preferably, the advertising vendor database 1132 includes sufficient information to allow the system 1100 to present each business with customized advertising options that may be appealing to each business.

The system 1100 may also include advertising tools 1134 that facilitate entry of advertising vendor information, presentation of advertising options to businesses, and selection of desired advertising options by a business. The advertising tools 1134 include, in one embodiment, a data entry tool 1136, an option presentation tool 1138, and an advertisement selector 1140. The data entry tool 1136 allows an advertising vendor to enter information about the type of advertising that the vendor offers, the advertising medium, pricing, circulation or viewership, and the like.

The option presentation tool 1138 is configured to determine, based on the information stored in the advertising vendor database 1132 and characteristics of a business, which advertising options will most likely appeal to the business. For example, the option presentation tool 1138 may determine that advertising in specialized legal publications may be of interest to law firms and that advertising that has broader reach, such as cable TV advertising, may appeal more to operators of department stores or other vendors of consumer goods.

The advertisement selector 1140 is configured to allow a business to select and purchase advertising. In one embodiment, the advertisement selector 1140 provides a mechanism for highlighting or otherwise selecting the advertising options presented by the option presentation tool 1138. Upon selection of one or more advertising options, the advertisement selector 1140 may transmit information to the appropriate advertising vendors for further processing and completion of an advertisement order. For example, the advertising vendors may follow up with the business to produce advertising content and to confirm details about an order such as date of placement, length of time that the advertisement will run, and the like. Preferably, the advertisement selector 1140 provides for calculation and processing of payment for an advertising order. In one embodiment, the system 1100 includes in the payment a transaction fee that is paid to the operator of the system 1100. Preferably, the system 1100 is configured to generate payment processing instructions to ensure that appropriate portions of payments are transferred to the advertising vendors and the operator of the system 1100. Alternatively, the system 1100 generates records having sufficient detail to allow a person or automated process to initiate transfers of funds to the appropriate parties.

In one embodiment, the system 1100 also includes “welcome wagon” functionality. Generally, a welcome wagon presents a new business with a list of local businesses that the new business may want to contact in order to help set up the new business' operations. For example, most new businesses will want to quickly set up phone service and Internet service and become familiar with restaurants, catering businesses, copy centers, and other service businesses in an area. Advantageously, the system 1100 allows businesses to sign up to be listed on a welcome wagon that may be displayed to new businesses at the point-of-license. The list of businesses included in the particular welcome wagon presented to a new business may differ depending on the business type of the new business, the size of the new business, and other factors.

In one embodiment, the system 1100 also provides an organization database 1140 and organization tools 1142 to allow entry of data about organizations and to allow businesses to sponsor organizations. The organization database 1140 may include date about organizations and data about organization sponsorships. The organization tools 1142 comprise, in one embodiment, a data entry tool 1144, a sponsorship tool 1146, and a sponsorship acceptance tool 1148. The data entry tool 1144 is configured to receive information about an organization, such as, for example, the name of the organization, where the organization meets, the goals or purposes of the organization, who may join the organization, dues for belonging to the organization, names and contact information for officers of the organization, membership lists, and the like.

The sponsorship tool 1146 is configured to allow businesses to sponsor an organization. In one embodiment, at the point-of-license of a business, the business is presented with the opportunity to sponsor one or more organizations. The sponsorship tool 1146 may determine sponsorship opportunities that are likely to appeal to the business by comparing information about the business with information about the various organizations. Alternatively or additionally, the sponsorship tool 1146 may determine which sponsorship opportunities to offer based on a preset list of opportunities, based on organizations paying a fee to be one of the organizations listed, or based on some other criteria. Preferably, upon determining which organizations to feature, the sponsorship tool 1146 presents a list of sponsorship opportunities to the business at the point-of-license. Preferably, the sponsorship tool 1146 also allows the business to search for other sponsorship opportunities, such as by entering keywords into a search tool, browsing through a directory or index of organizations, or the like.

Upon presenting featured organizations and giving the business an opportunity to search for other organizations, the sponsorship tool 1146 provides a mechanism for the business to select one or more organizations to sponsor. The sponsorship tool 1146 presents terms of sponsorship, such as that the business pays a one-time or periodic fee for support of the organization. The sponsorship tool 1146 may also present information about what the organization will do with the money and what, if anything, the business will receive in return for sponsorship. For example, in some cases the business may be entitled to have a logo or advertisement placed on an organization's website in return for sponsorship. In other cases the business may be allowed to place the organization's logo on the business' website, along with an indication that the business is a sponsor of the organization. Alternatively or additionally, the business may receive tickets to events run by the organization, such as, for example, tickets to performances at a community symphony orchestra. Organizations are free to offer any benefit for sponsorship, as desired, and such benefits may be presented by the sponsorship tool 1146 to provide incentives for businesses to sponsor the organizations.

In one embodiment, the sponsorship tool 1146 transmits a message to an organization when a business has selected the organization for sponsorship. In one embodiment, a sponsorship acceptance tool 1148 is provided to allow the sponsorship to accept or reject the sponsorship. For example, the sponsorship tool 1146 may send an electronic mail message to the organization with a notice indicating that a particular business desires to sponsor the organization, an indication of the amount of the sponsorship, and links for accepting or rejecting the sponsorship. The organization may accept the sponsorship by clicking on the accept link or may reject the sponsorship by clicking on the reject link. Any other mechanism for informing the organization about the sponsorship and allowing the organization to accept or reject the sponsorship may be used. Advantageously, allowing the organization to accept or reject a sponsorship allows the organization to control which businesses the organization is associated with. This prevents organizations from being associated with businesses that the organization does not want to support or that the organization believes may tarnish the image of the organization.

Preferably, upon selection of a sponsorship opportunity by a business and acceptance of the sponsorship by an organization, the sponsorship tool 1146 automatically completes transactions related to the sponsorship. For example, in one embodiment, the sponsorship tool 1146 automatically updates a publicly-accessible listing that shows that the business is a sponsor for the organization. The publicly-accessible listing may be shown to users who search for information about the organization or to users who search for information about the sponsoring business. In addition, the sponsorship tool 1146 may collect any payment that is required for sponsorship and distribute a portion of the funds to the organization and a portion of the funds to the operator of the system 1100. Alternatively or additionally, the sponsorship tool 1146 may create records or messages of sponsorship transactions so as to assist a human user or automated process to perform any transactions necessary to bring about the sponsorship. For example, a message may be sent to the organization so that the organization can update the organization's website to reflect that the business has become a sponsor.

In one embodiment, the system 1100 also provides data and tools for managing business opportunities for governments and private entities. We use the phrase “business opportunity” to refer generally to a broad range of information related to opportunities to conduct a business transaction. Such information includes, for example, information about opportunities to bid for government contracts, job offers or postings of open positions (whether for government jobs or private-sector jobs), requests for proposals or requests for quotations entered by private entities, and the like. In one embodiment, a business opportunity database 1150 includes data about business opportunities offered by both government and private entities. The business opportunity database 1150 includes such information as what opportunity is being offered or requested, what type of business does the business opportunity pertain to, what is required to respond to the business opportunity (e.g. in the case of a bid, how does a business submit a bid), when is the deadline for response, and the like.

In one embodiment, the system 1100 also includes business opportunity tools 1152 for managing posting, searching, and response to business opportunities. The business opportunity tools 1152 may comprise an opportunity entry tool 1154, a search tool 1156, and a response tool 1158. The opportunity entry tool 1154 is configured to receive information from government or private entities regarding business opportunities. The business opportunities may include information about what is being sought (e.g. a bid is sought for building a bridge over a river or a proposal is sought for replacing a private business' computer system), what types of businesses or individuals are expected to respond, when is the deadline for response, optionally a range of expected prices, and the like. Preferably, the entered data includes sufficient data to match the business opportunities with businesses or individuals that may be suitable for the business opportunity.

A skilled artisan will appreciate that factors for determining whether a business or individual is suitable for a business opportunity differ based on the nature of the business opportunity. For example, only construction companies are typically deemed suitable to bid for a government construction project. Similarly, only attorneys or soon-to-graduate law students are deemed suitable to respond to job openings for attorneys. Other factors that may be relevant for various business opportunities include type of business (determined, in one embodiment, using a classification system such as the NAICS or the SIC), size of a business, cash flow of a business, educational level of an individual, experience of an individual, and the like.

The opportunity search tool 1156 matches business opportunities with businesses that may be suitable for the business opportunity. The search tool 1156 may be invoked by a business or individual searching for business opportunities of a certain type. For example, a business may access the search tool 1156 and enter a search for the types of business opportunities that the business is looking for. The search tool 1156 then finds matching business opportunities and presents them to the business. The business can then select business opportunities that the business desires to participate in (e.g. by submitting a bid, accepting an offer, or the like).

Alternatively, the search tool 1156 may be invoked by the system 1100 or the government or private entity that entered the information about the business opportunity. For example, the system 1100 can periodically execute the search tool 1156 to match business opportunities with businesses that may be suitable for the business opportunities. Upon completing such a search, the system 1100 can send a notice to the matching businesses and invite the matching businesses to participate in the business opportunities. In this manner, the system 1100 can help government or private entities spread the word of upcoming business opportunities to relevant businesses. Alternatively or additionally, government or private entities may invoke the search tool 1156 to find desirable businesses to whom to send business opportunities. A government or private entity can then review the results of such a search and select which, if any, businesses to send the business opportunities to.

As described above, the foregoing embodiments function as a business opportunity service that distributes information about business opportunities to potentially interested parties. These embodiments are powerful tools for attracting as many relevant participants in a business opportunity (e.g. potential bidders) as possible. Another optional component is the response entry tool 1158. This optional component is configured to receive and process responses to business opportunities. In one embodiment, the response entry tool 1158 transmits responses to the government or private entity that entered the business opportunity, thus allowing the government or private entity to determine which business or individual to award the business opportunity to. Allowing the government or private entity to determine whom to award the business opportunity to is particularly advantageous when a business opportunity will be awarded based on several factors and not just price.

In one embodiment, the system 1100 gives a business, at the point-of-license, the option to sign up to receive information about business opportunities stored in the business opportunity database 1150. In one embodiment, the business may immediately search for outstanding or upcoming business opportunities at the point-of-license. In an alternative embodiment, the system 1100 does not allow the business to search for outstanding or upcoming business opportunities until the business' license has been approved. Alternatively or additionally, the business may sign up to receive alerts of newly added business opportunities. The business may specify which types of business opportunities it wants to receive, such as upcoming government bids for construction projects. Another alternative is that the business may receive login information that allows the business to log in to the search tool 1156 and enter searches for business opportunities.

The business opportunities database 1150 and the business opportunities tools 1152 can be used in many contexts related to any business transaction that a business might want to enter into. Some examples of business opportunities include government or private bid requests, requests for proposal, requests for quotation, job openings, offers for sale, other offers, and the like.

As illustrated by FIG. 11, the system 1100 preferably is accessible via a network 1160 to a variety of users, including, without limitation, business users 1162, government users 1164, organization users 1166, advertising vendor users 1168, school users 1170, search engine users 1172, and other users 1174. A skilled artisan will appreciate, in light of this disclosure, that many other types of users that are not explicitly described herein may desire to have access to the system 1100 to access the data and functions described herein. The system 1100 may advantageously be adapted to allow all such users to have access to the system 1100. Preferably, the system 1100 is configured with appropriate security measures to allow users to access information useful to them but preventing unauthorized users from accessing sensitive information.

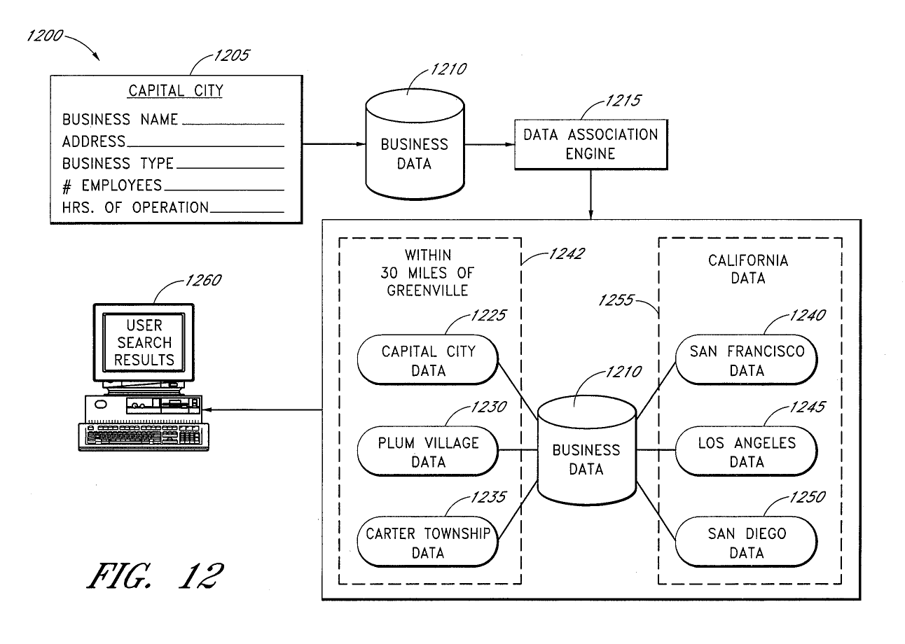

FIG. 12 is a process flow diagram that illustrates how components of one embodiment of the system 1100 perform a process of collecting business data at the point-of-license and generating a search engine of localized business data. In a process 1200, an electronic data entry form 1205 is presented to a business at the point-of-license. The business enters license business data and non-license business data into the form 1205. The entered form data is then transmitted to and stored in a business database 1210. A data association engine 1215 detects associations between data stored in the business database 1210 and organizes the data in a manner that is adapted for localized search engines of business data.

The process of association and organization of the business data results in a network of localized search engines 1220. The localized search engines 1220 include, for example, a search engine that includes business data of business within Capital City 1225, a search engine for Plum Village 1230, a search engine for Carter Township 1235, a search engine for San Francisco 1240, a search engine for Los Angeles 1245, and a search engine for San Diego 1250. FIG. 12 also illustrates the hierarchical nature of the data stored in the business database 1210. For example, the business data can be organized into separate data sets for cities, but can also be organized into separate data sets for broader geographic areas, such as the data set for businesses within 30 miles of Greenville 1242 and the data set for businesses within California 1255.

A skilled artisan will appreciate in light of this disclosure that the data sets illustrated as part of the network of localized search engines 1220 can be but need not be physically separate data sets. In one embodiment, the data association engine 1215 organizes each data set as a physically separate database. Alternatively, the data sets may all be stored in one or more common databases, but with sufficient data to logically separate the individual data sets. In embodiments in which the data sets are logically defined but not physically separated, a database management system or other system for querying information may execute a query to generate an appropriate data set for searching by a user. For example, if a user wants to search for all businesses in Capital City, a database management system can run a query that limits results to businesses located in Capital City.

After the generation of a network of localized search engines 1220, a user search terminal 1260 may be used to create search terms for the data. A user enters search terms into the user search terminal 1260, the user search terminal 1260 transmits the terms one or more of the network of search engines 1220, an appropriate search engine executes a query on the search terms and generates search results, and the user search results are returned for display on the user search terminal 1260. Preferably, the user search terminal 1260 is a computer running a web browser and that is connected to a network such as the Internet. The user terminal 1260 may alternatively be a computer connected to a network that uses some other software (not a web browser) for accessing the network. The user search terminal 1260 may alternatively be a kiosk connected to a local area network or wide area network. The user search terminal 1260 may alternatively be a wireless device, a telephone, or any other electronic device that may receive electronic information.

In various embodiments of the system 1100 and the processes described herein, information about the location of a user may be used as one or more parameters in a search. One example of such user locational data is data from a GPS system that indicates the location of the user. Another example of user locational data is information entered by the user to indicate roughly where the user is. For example, the user can enter an address of a nearby building. Alternatively or additionally, the user can enter a code indicative of a known geographical location. In one embodiment, an operator of the system 1100 can provide stickers with codes to participating businesses. The participating businesses can affix the codes to their businesses in a visible location. A user can enter a code from the sticker, suggesting that the user is at the location where the sticker is affixed. The system 1100 can then determine from the sticker code where the user is and take the user's location into account for determining search results. Advantageously, the system 1100 is able not just to provide search results related to the location but also to provide certified information of which nearby businesses are licensed.

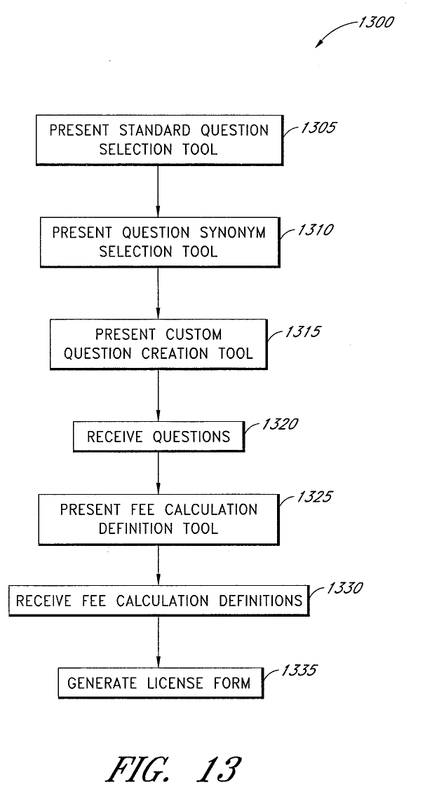

FIG. 13 is a flowchart depicting one embodiment of a process of creating an electronic license form. A process 1300 of creating an electronic license form may begin with a block 1305, in which the process 1300 presents a standard question selector. In general, a standard question selector allows a user to select one or more questions that are commonly-used. In one embodiment, the standard question selector allows selection of questions that are stored in a standard question database. The standard question selector tool presented in the block 1305 may have one or more of the characteristics of the standard question selector 1112 of FIG. 11.

The process 1300 may proceed, in a block 1310, to present a question synonym selector. In general, a question synonym selector allows a user to select one or more questions that are substantially equivalent in meaning to standard questions but that are worded differently. In one embodiment, the question synonym selector allows selection of questions that are stored in a question synonym database. The question synonym selector may have one or more of the characteristics of the questions synonym selector 1114 of FIG. 11.

The process 1300 may proceed, in a block 1315, to present a custom question creator. In general, a custom question creator allows a user to create custom questions that are not stored in a database of standard questions or question synonyms. The custom question creator may have one or more of the characteristics of the custom question creator 1116 of FIG. 11. Custom questions that are created may be stored in a database. Custom questions that are created may become standard questions or question synonyms if it is determined that they have become commonly-used questions.

The process 1300 may proceed, in a block 1320, to receive questions. In one embodiment, the process 1300 receives questions from a user. Alternatively or additionally, the process 1300 receives questions from an automated process or looks up the questions from a database. In one embodiment, the user enters the questions that are received by the process 1300 using one or more of a standard question selector, a question synonym selector, and a custom question creator, as referenced in the blocks 1305, 1310, and 1315 and as depicted in FIG. 11. The process 1300 may be performed such that only one of the foregoing tools for entering questions is used. Accordingly, the blocks 1305, 1310, and 1315 are optional.

The process 1300 may proceed, in a block 1325, to present a fee calculation definition tool. In general, a fee calculation definition tool is a user interface that allows a user to define formulae for calculating fees without requiring programming skills. The fee calculation definition tool may have one or more of the characteristics of the fee calculation definition tool 1118 of FIG. 11. The fee calculation definition tool may present a user interface that is similar to the illustrative user interface of FIGS. 18A, 18B, and 18C.

The process 1300 may proceed, in a block 1330, to receive fee definitions. In one embodiment, the fee definitions are received from a user. In one embodiment, the user from whom the fee definitions are received enters the fee definitions by using the fee calculation tool referenced by the block 1325 and depicted on FIG. 11.

The process 1300 may proceed, in a block 1335, to generate an electronic license form. In one embodiment, the process 1300 generates the license form by encoding the questions received in the block 1320 in a particular order and format and encoding fee calculation logic corresponding to the fee calculation definitions received in the block 1330. In one embodiment, the process 1300 stores the generated license form in a form database such as is depicted as component 1120 on FIG. 11.

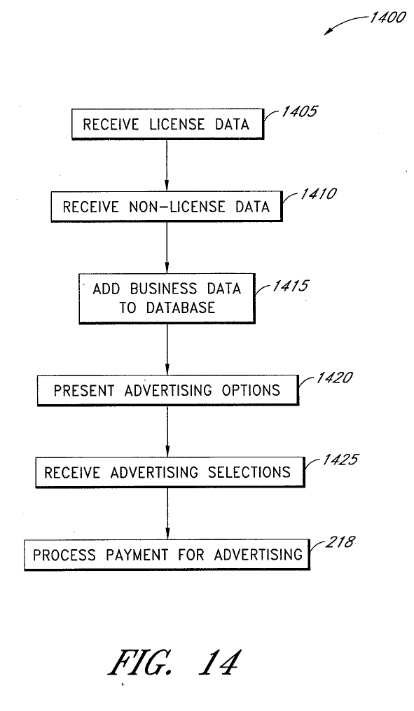

FIG. 14 is a flowchart that depicts one embodiment of a process of presenting advertising options at the point-of-license. As illustrated, a process 1400 of presenting advertising options at the point-of-license may begin, at a block 1405, by receiving license data. In one embodiment, license data comprises business data that a city or government entity requires as part of the process of licensing a business. In one embodiment, the process 1400 receives the license data from a user associated with a business. In one embodiment, the process 1400 receives the license data from a remote terminal connected to a network such as the Internet. A skilled artisan will appreciate that receiving license data facilitates the city's ability to approve or reject business licenses. In one embodiment, the process 1400 includes the operation of approving a business license.

The process 1400 may proceed, in a block 1410, to receive non-license data. In one embodiment, non-license data comprises business data useful for classifying or searching for businesses but that is not required by a city or government entity as part of the process of licensing a business. Advantageously, receiving non-license data at substantially the same time as receiving license data has the advantage of increasing the chances that a business will enter the non-license data. As businesses are required to provide license data, the time at which they enter license data is a good time to keep the business' attention and request that the business add some additional information.

The process 1400 may proceed, in a block 1415 to add the license business data and the non-license business data to a searchable database of business data. In one embodiment, adding the license business data and the non-license business data to a searchable database of business data includes creating a database of business data that may be geographically-localized. In one embodiment, adding the business data to a database includes using a data association engine to detect associations between different data items and organizing the data in a way to make it easier to categorize and search.

The process 1400 may proceed, in a block 1420, to present advertising options. In one embodiment, the process 1400 presents advertising options that are deemed to be effective advertising options for the business that is entering business data as part of the process of being licensed. In one embodiment, the determination of which advertising is deemed to be effective is based at least in part on the entered business data and previously entered information about advertising vendors' advertising options. For example, a vendor of consumer products may be presented with advertising with a broad reach such as cable TV advertising. A more specialized business, such as a law firm, may be presented advertising options with a more narrow focus, such as advertising in legal industry publications.

The process 1400 may proceed, in a block 1425, to receive advertising selections. In one embodiment, the process 1400 allows a business user to select one or more of the advertising selections presented in the block 1420. Alternatively or additionally, the business user may be allowed to select advertising options that were not presented. For example, in one embodiment, the advertising options that are deemed to be most effective for the business are presented in the block 1420, but the business user can override this determination by selecting an advertising option that the process 1400 deems to be less effective.

The process 1400 may include an optional operation (not shown) of adding the received advertising selections to a shopping cart. In such an embodiment, the user can add or remove advertising selections to or from the shopping cart. Advantageously, this allows the business user to purchase advertising selections in one transaction rather than piece-by-piece. In one embodiment, the shopping cart may include advertising selections from different advertising vendors.

The process 1400 may proceed, in a block 1430, to process payment for the business user's advertising selections. In one embodiment, the process 1400 collects payment for the advertising vendors and automatically transfers an appropriate amount to each advertising vendor. Preferably, the process 1400 also transfers a transaction fee, if applicable, to the operator of the process 1400. In another embodiment, the entire aggregate fee is charged and collected as a single sum. It will be appreciated that numerous options exist for charging and collecting for advertising services and the invention is not limited by any particular options.

The process 1400 may include an optional operation (not shown) of transmitting information about the selected advertising options to the advertising vendors that sell the advertising options. Advantageously, transmitting such information to the advertising vendors allows the advertising vendors to complete a transaction, such as by contacting the business and confirming details of an advertising order.

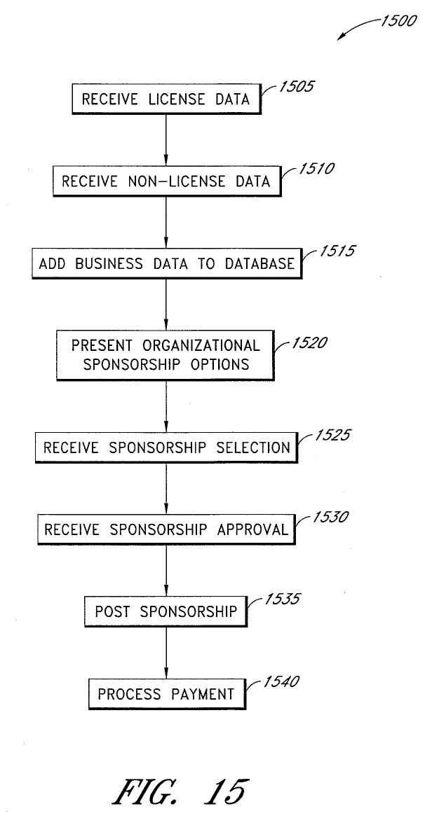

FIG. 15 is a flowchart that depicts one embodiment of a process of presenting options for sponsoring organizations at the point-of-license. As illustrated, a process 1500 of presenting organizational sponsorship options at the point-of-license may begin, at a block 1505, by receiving license data. In one embodiment, license data comprises business data that a city or government entity requires as part of the process of licensing a business. In one embodiment, the process 1500 receives the license data from a user associated with a business. In one embodiment, the process 1500 receives the license data from a remote terminal connected to a network such as the Internet. A skilled artisan will appreciate that receiving license data facilitates the city's ability to approve or reject business licenses. In one embodiment, the process 1500 includes the operation of approving a business license.

The process 1500 may proceed, in a block 1510, to receive non-license data. In one embodiment, non-license data comprises business data useful for classifying or searching for businesses but that is not required by a city or government entity as part of the process of licensing a business. Advantageously, receiving non-license data at substantially the same time as receiving license data has the advantage of increasing the chances that a business will enter the non-license data. As businesses are required to provide license data, the time at which they enter license data is a good time to keep the business' attention and request that the business add some additional information.

The process 1500 may proceed, in a block 1515 to add the license business data and the non-license business data to a searchable database of business data. In one embodiment, adding the license business data and the non-license business data to a searchable database of business data includes creating a database of business data that may be geographically-localized. In one embodiment, adding the business data to a database includes using a data association engine to detect associations between different data items and organizing the data in a way to make it easier to categorize and search.

The process 1500 may proceed, in a block 1520, to present organizational sponsorship options. In one embodiment, the process 1500 presents organizational sponsorship options that are expected to interest the business that is entering business data as part of the process of being licensed. In one embodiment, the determination of which organizational sponsorship is expected to interest the business is based at least in part on the entered business data and previously entered information about organizations. For example, a law firm may be presented the opportunity to sponsor a law-related organization, such as a public interest law group. As additional examples, a sporting goods business may be offered the opportunity to sponsor a local little league baseball team, or a music company may be offered the chance to sponsor a concert in a local park.

The process 1500 may proceed, in a block 1525, to receive sponsorship selections. In one embodiment, the process 1500 allows a business user to select one or more of the sponsorship options presented in the block 1520. Alternatively or additionally, the business user may be allowed to select sponsorship options that were not presented. For example, in one embodiment, the sponsorship options that are expected to be most interesting to the business are presented in the block 1520, but the business user can override this determination by selecting a sponsorship option that the process 1500 deems to be less interesting.

The process 1500 may include an optional operation (not shown) of adding the received sponsorship selections to a shopping cart. In such an embodiment, the user can add or remove sponsorship selections to or from the shopping cart. Advantageously, this allows the business user to purchase sponsorship selections in one transaction rather than piece-by-piece. In one embodiment, the shopping cart may include sponsorship selections from different organizations.

The process 1500 may proceed, in a block 1530, to receive sponsorship approval. In one embodiment, the organization that a business wants to sponsor is sent a notification, such as in an electronic mail message, of the proposed sponsorship. The organization can then approve or reject the sponsorship, such as by clicking on approve or reject links in an electronic mail message. Advantageously, the option to approve or reject a sponsorship allows the organization to avoid being sponsored by businesses that the organization believes do not share the values of the organization or that would otherwise cast the organization in an unfavorable or undesirable light.

The process 1500 may proceed, in a block 1535, to post information about the sponsorship to an online site. In one embodiment, the information about the sponsorship, which may include a sponsorship logo or small advertisement, is posted with information about the sponsoring business and with information about the organization. The sponsorship information may also be posted on a city website having information about local organizations and their sponsors. Advantageously, the posting of organization sponsorship on websites with local community information allows a business to demonstrate its commitment to the community.

The process 1500 may proceed, in a block 1540, to process payment for the business user's sponsorship selections. In one embodiment, the process 1500 collects payment for the organizations being sponsored and automatically transfers an appropriate amount to each organization. Preferably, the process 1500 also transfers a transaction fee, if applicable, to the operator of the process 1500.

The process 1500 may include an optional operation (not shown) of transmitting information about the selected sponsorship options to the organizations that are to be sponsored. Advantageously, transmitting such information to the organizations allows the organizations to complete additional details about the sponsorship, such as posting physical signs regarding the sponsorship at the organization's facilities.

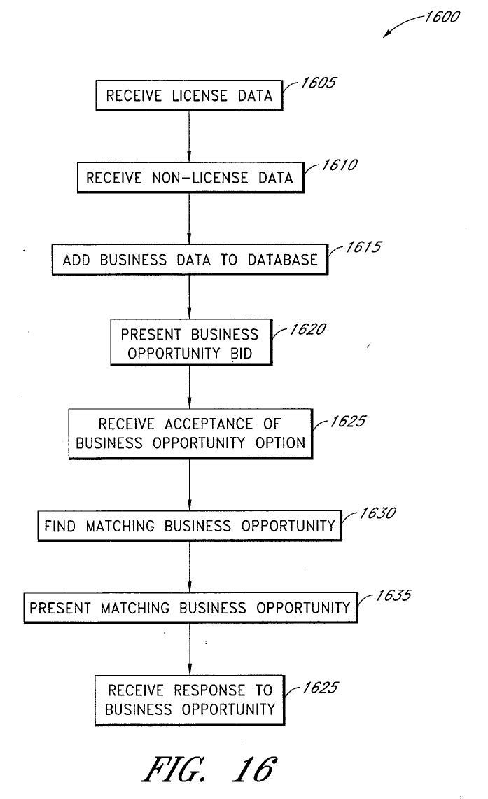

FIG. 16 is a flowchart that depicts one embodiment of a process of providing access to a business opportunity service at the point-of-license. As illustrated, a process 1600 of providing access to a business opportunity service at the point-of-license may begin, at a block 1605, by receiving license data. In one embodiment, license data comprises business data that a city or government entity requires as part of the process of licensing a business. In one embodiment, the process 1600 receives the license data from a user associated with a business. In one embodiment, the process 1600 receives the license data from a remote terminal connected to a network such as the Internet. A skilled artisan will appreciate that receiving license data facilitates the city's ability to approve or reject business licenses. In one embodiment, the process 1600 includes the operation of approving a business license.

The process 1600 may proceed, in a block 1610, to receive non-license data. In one embodiment, non-license data comprises business data useful for classifying or searching for businesses but that is not required by a city or government entity as part of the process of licensing a business. Advantageously, receiving non-license data at substantially the same time as receiving license data has the advantage of increasing the chances that a business will enter the non-license data. As businesses are required to provide license data, the time at which they enter license data with business information close at hand or in mind is a good time to keep the business' attention and request that the business add some additional information.

The process 1600 may proceed, in a block 1615 to add the license business data and the non-license business data to a searchable database of business data. In one embodiment, adding the license business data and the non-license business data to a searchable database of business data includes creating a database of business data that may be geographically-localized. In one embodiment, adding the business data to a database includes using a data association engine to detect associations between different data items and organizing the data in a way to make it easier to categorize and search.

The process 1600 may proceed, in a block 1620, to present an option to sign up for a business opportunity service. We use the phrase “business opportunity service” to refer to a service that stores and provides information about a broad range of business opportunities. Business opportunities may include, for example, requests for proposal, requests for quotation, offers, job openings, and any other opportunity to enter into a business transaction. Accordingly, signing up for the business opportunity service allows a business to access information about business opportunities posted by government or private entities. In one embodiment the service also allow businesses to post business opportunities for other businesses or individuals. A skilled artisan will appreciate that some business opportunities are directed to individuals rather than other businesses. For example, a job opening is a business opportunity for an individual rather than for a business.

The process 1600 may proceed, in a block 1625, to receive acceptance of the business opportunity service option. In one embodiment, when a business user accepts the business opportunity service option, the process 1600 creates a flag or record indicating that the business user is a participant in the business opportunity service option. Preferably, the process 1600 creates a user account that allows the user to access outstanding or future business opportunities. In addition, the user account may allow the user to post business opportunities.

The process 1600 may proceed, in a block 1630, to find a business opportunity that matches a type of bid opportunity that may appeal to the business user. In one embodiment, the operation of finding a matching business opportunity is initiated by the business user by entering search terms or criteria into a search tool configured to find business opportunities. For example, after signing up for the business opportunity service, the business user may visit a website that provides search capability and may run a search for current business opportunities. The process 1600 may then find any matching business opportunities. A skilled artisan will appreciate in light of this disclosure that the operation of finding matching business opportunities does not necessarily take place at the point-of-license. Indeed, this operation may occur months or years after the point-of-license when the business owner decides to visit the website to search for business opportunities.

In one embodiment, the operation of finding a matching business opportunity is initiated by the process 1600 by periodically running an automated process to match business opportunities with businesses. Such automated matching may take into account factors such as the type of business opportunity, the business classification of each business, the size of the project and the size of the business (e.g. to determine whether the business is likely capable of handling the size of the project), and any other factor for determining whether a particular business opportunity is likely to be of interest to the business. Such automated matching may advantageously assist a government or private entity to find appropriate businesses to present with a business opportunity without requiring the businesses to run a search for the business opportunities.

In one embodiment, the operation of finding a matching business opportunity is initiated by the process 1600 in a manner that uses both an automated process and input from the business. For example, at the point-of-license, the business may enter preferences of the type of business opportunities that the business wants to be matched with. For example, the business may indicate that it wants to be matched with government bid opportunities for construction projects and offers to sell construction equipment but that it does not want to be matched with job openings. The process 1600 may then periodically run an automated process for matching the business with business opportunities that considers the business' preferences in addition to the factors set forth above.

The process 1600 may proceed, in a block 1635, to present matching business opportunities. In one embodiment, the process 1600 presents matching business opportunities on a webpage listing of business opportunities. Alternatively or additionally, the process 1600 may transmit the matching business opportunities to the matched business or individual, such as in an electronic mail message or a text message.

The process 1600 may proceed, in a block 1640, to receive a response to a business opportunity. For example, in the context of a government bid opportunity, the response received may be a bid from a business. In response to a job opening opportunity, the response may be a cover letter and resume. In one embodiment, the process 1600 forwards any response to a business opportunity to the entity that posted the business opportunity. Advantageously, forwarding the response to the posting entity allows the entity to determine which response (e.g. bid, proposal, resume, or the like) to accept.

In some embodiments, the process 1600 also includes mechanisms for the operator of the process 1600 to be paid one or more transaction fees during the process 1600. For example, in one embodiment, the operator receives a registration or subscription fee when a business signs up for the business opportunity service. Alternatively or additionally, the operator receives a fee when a government or private entity posts a business opportunity. Alternatively or additionally, the operator receives a fee when a business or individual submits a response. Alternatively or additionally, the operator receives a fee when a transaction is completed (e.g. when a government entity accepts a bid and enters a contract with the winning bidder). Any of the foregoing fees may be flat fees, based on a percentage of some measurement, or based on a size of a posting or response.

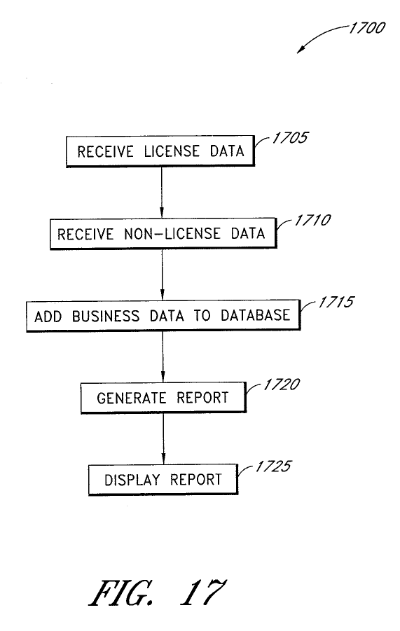

FIG. 17 is a flowchart that depicts one embodiment of a process of generating and displaying a report based on business data entered at the point-of-license. As illustrated, a process 1700 of generating and displaying a report based on business data entered at the point-of-license may begin, at a block 1705, by receiving license data. In one embodiment, license data comprises business data that a city or government entity requires as part of the process of licensing a business. In one embodiment, the process 1700 receives the license data from a user associated with a business. In one embodiment, the process 1700 receives the license data from a remote terminal connected to a network such as the Internet. A skilled artisan will appreciate that receiving license data facilitates the city's ability to approve or reject business licenses. In one embodiment, the process 1700 includes the operation of approving a business license.

The process 1700 may proceed, in a block 1710, to receive non-license data. In one embodiment, non-license data comprises business data useful for classifying or searching for businesses but that is not required by a city or government entity as part of the process of licensing a business. Advantageously, receiving non-license data at substantially the same time as receiving license data has the advantage of increasing the chances that a business will enter the non-license data. As businesses are required to provide license data, the time at which they enter license data is a good time to keep the business' attention and request that the business add some additional information.

The process 1700 may proceed, in a block 1715, to add the license business data and the non-license business data to a searchable database of business data. In one embodiment, adding the license business data and the non-license business data to a searchable database of business data includes creating a database of business data that may be geographically-localized. In one embodiment, adding the business data to a database includes using a data association engine to detect associations between different data items and organizing the data in a way to make it easier to categorize and search.

The process 1700 may proceed, in a block 1720, to generate a report based on the business data. In one embodiment, the generation of the report is initiated by a user entering search terms into a search engine of the business data. In one embodiment, the generation of the report is initiated by a user entering a query into a demographic or statistics reporting tool. Such a demographic or statistics reporting tool allows a user to request aggregated information such as the number and average size of construction businesses in California in each year from 2006 to 2008. Advantageously, the reporting tool has access to historical as well as current business data entered at the point-of-license, such that the reporting tool can generate reports that show trends in data.

The process 1700 may proceed, in a block 1725, to display the generated report. In one embodiment, displaying the generated report comprises encoding the report data into html format and transmitting the encoded report to a user's web browser for display. In one embodiment, displaying the generated report comprises printing the report to a hard copy. For example, displaying the generated report may be printing a paper directory. Alternatively, displaying the generated report may be creating an electronic directory such as on a CD. In addition, displaying the generated report may include making an audible report rather than a visual report. For example, displaying the generated report may include sending an automatically generated voicemail message to a user's voicemail box.

As illustrated by component 1170 on FIG. 11, one type of organization that may interact with the system 1100 and the processes described above is a school. Schools may interact with any of the features, components, and processes that are described above. For example, schools may be sponsored by businesses just like any other organization. In addition, schools may post business opportunities in the business opportunities database 1150 or even respond to such opportunities. In some embodiments, schools are treated much like other organizations but have separate databases and tools for managing information related to schools' interaction with the system 1100 and with the businesses that have access to the system 1100.

In addition to allowing governments to use the system 1100 for collecting licensing information, the system 1100 preferably includes tools for managing business licenses. For example, the system 1100 may keep track of licensing expiration and renewal, transmit messages to businesses reminding them to renew a license that is about to expire, keep track of additional licenses that are required but have not been applied for, keep track of fees payments and past due accounts, and the like.

In addition the system 1100 preferably integrates with existing government systems. In one embodiment, an Application Programming Interface (“API”) is provided to allow existing government systems to communicate with the system 1100 and to access data stored in the system 1100. Advantageously, providing an API allows governments to take advantage of the power of the system 1100 without abandoning existing or legacy systems that may contain substantial amounts of data.

FIGS. 18A, 18B, and 18C are illustrative worksheets that assist a user to create fee calculation logic without programming experience. The user simply selects the types of fees that are applicable in a given city and fills in numbers and other information to set the specific rates for those fees. These figures are illustrative only and the invention is not limited to the particular format or ordering of the worksheets.

Preferably, the system 1100 collects as much information about government entities and businesses as possible. For example, in one embodiment, the system 1100 collects the following information from government entities: primary contact name, primary contact title, login username, login password, email, phone number and extension, security question, security question answer, date city information confirmed, date terms of agreement accepted, government entity name, address, phone, fax, website, department that handles business licenses, hours for that department, seal or logo, government entity tagline/slogan, name of business license form, additional lines, whether the government entity has multiple versions of the application (e.g. for businesses inside vs. outside the city, independent contractors, etc.), and whether the government entity requires additional forms for a business license.

In addition, for each question that a government entity includes on a form, the system 1100 preferably requests the following information: whether to include the question on the form, whether the answer to the question is public or private, whether the business is required to answer the question, which wording for the question to use, any description or disclaimer for the question, the location of the question on the form, and whether the licensing process changes based on the answer to the question. With respect to the question of whether the licensing process changes based on the answer to the question, the system 1100 preferably determines what changes may be required depending on answer (e.g. whether different forms must be filled out, different limitations are imposed, or the like) and the system 1100 then makes sure that the licensing process proceeds correctly (e.g. all forms are filled out and the like).

In addition, the system 1100 preferably requests the following government internally generated information: whether the license is approved, date fees paid, payment collected by, expiration date, effective date, whether it's a new application, business license #, a system 1100 assigned license # (this is automatically generated by the system and the government does not have access to it), received by, planning & development approved?, date planning & development approved, zoning, zoning clearance, code section, certificate of use and occupancy, planning & development notes, fire department approved?, date fire department approved, fire department notes, police department approved?, date police department approved, police department notes, public works approved?, date public works approved, public works notes, has the application been microfilmed?

In addition, the system 1100 preferably obtains the following information for businesses: login username, login password, date accepted by the system 1100, change of ownership information, change of address information, change of status or DBA information, changes to other information, is this a renewal license?, additional licenses/permits in the government entity, additional branches/offices/locations, inside or outside the government entity?, home based? (if yes, the address will not be listed on their licensed business directory page), is this a permit for a special event?, top level classification, NAICS/SIC category (this will trigger the appropriate fee calculation process and will be valuable in management reports), rental property (if applicable), category assigned by the system 1100 (used to facilitate licensed business directory searches), business name, business address (not listed in the directory if the business is home-based), mailing address, email, business website, business fax, business phone, contact name, title, business description, are you sharing tenant space with anyone?, business start date (for the directory, the system will calculate the years in business), business owner(s) name(s), title(s), residence address(es), home phone(s), cell phone(s), ownership type, drivers license #, professional license #, contractor #, contractor classification (if applicable), expiration date, federal tax ID #, Social Security #, Sales Tax #, Other State License No. (if applicable), SEIN State Employment ID #, Standard Industrial Class (SIC), Hours of Operation of your business (this data is not currently typically collected on a license application but will be valuable to the system 1100), extended/seasonal hours of operation, number of employees, square footage of business, no. of units or spaces, no. of available parking spaces, annual gross receipts, 24 hour contact name, 24 hour contact address, 24 hour contact phone, name of landlord if rental, address of landlord if rental, previous business name, previous business address, previous business owner's name, what was the previous use of space you wish to lease?, when did the previous user vacate premise?, additional city business locations, address, square footage, rental units, address of rental property, no. of units, revenue received, does your business plan to install a burglar alarm?, vending machine no., vending machine type, will there be entertainment?, dancing?, alcohol served?, ABC #, vehicle year, make, license no., opt in for the licensed business directory?, business description (for the directory page), phone number (this will default to the above entered phone number, but can be changed), toll free number, email (this will default to the above entered email, but can be changed), fax (this will default to the above entered fax, but can be changed), languages spoken, years in business (calculated based on the start date), Directory information: 1 picture (enhanced listing will allow additional ones to be entered), 1 messages or announcement (enhanced listing will allow additional ones to be entered), 1 types/brand of products or services offered (enhanced listing will allow additional ones to be entered), multiple pictures (with enhanced listing), multiple messages/announcements (with enhanced listing), multiple types/brands of products or services offered (with enhanced listing), seasonal/holiday offers, method of contact for reminders to update profile, contact information (defaulted from the business directory info, but can be changed), Welcome Wagon information: welcome wagon description, special B2B offers, special B2C offers, picture, Sponsorship information: organization name, sponsor ad title, sponsor ad description, level of sponsorship (each level is priced differently and offers a different prominence on the organization's page), ad name, ad description, ad level, web address that the ad links to (defaults to directory listing but can be changed), Business Opportunity information: bid on contracts inside the city?, bid on contracts outside the city?, offers selected, information required for each offer, payment method selected, opt in to the email list for free promotional opportunity information?, Payment preferences: payment through the system's automated system or directly to the government?, name on card/bank account, billing address, billing phone, card number (if applicable), account number (if applicable), verification code (if applicable), Acceptance of terms: accept the city terms of agreement, responsible party (this will default to the owner information entered above, but can be changed), title, date, signature (electronic authorization).

In addition, the system 1100 preferably obtains the following information for advertising vendors: name, address, phone number, fax number, email, website address, contact name, contact title, customer referrals, type of media, description of services, list of system offers, advertising reach for each service (CPMs), pricing, payment options, video demonstration.

In addition, the system 1100 preferably obtains the following information for organizations: organization title, primary contact name, email, phone, fax, web address, description, picture(s), logo, announcements, recurring event date (can add multiple events), recurring event information (can add multiple events), special event date (can add multiple events), special event information (can add multiple events), category, membership requirements, other comments, business sponsorship approval information (triggered when a business makes a sponsorship offer): name approving the sponsorship, title, email, date of approval, phone number, name check should be made out to, address to send check to, Tax ID number.

The embodiments disclosed herein may be implemented in hardware, software, firmware, or any combination of hardware, software, and firmware. For example, the tools and components such as the form design tools 1110, the business data tools 1124, the advertising tools 1134, and the like, may be implemented as software programmed for execution on a general purpose computer. Alternatively, such tools may be implemented as hardware circuits, firmware, or some combination of software, hardware, and firmware. If implemented in software, each of the tools comprises computer-executable instructions stored in a computer-readable medium and configured, when executed by a computer, to perform the functions set forth in this disclosure. If implemented in hardware, each of the tools comprises electronic circuitry configured to perform the functions set forth in this disclosure. If implemented in firmware, each of the tools comprise hardware components that have programmed thereon instructions that, when executed by a processor, perform the functions set forth in this disclosure.

In addition, the operations set forth in the processes described in this disclosure may be performed by hardware, software, firmware, or any combination of hardware, software, and firmware. For example, the operations may be performed by a computer processor executing computer-executable instructions configured, when executed by a computer, to perform the operations as set forth herein. As with the tools, the process operations may also be performed by hardware or firmware or any combination of software, hardware, and firmware.

For ease of understanding, the term “tool” is a generic term for a tool that can be implemented in software, hardware, firmware, of any combination of software, hardware, and firmware, but that does not require any one of these specific implementations. Similarly, the terms “selector,” “creator,” “engine,” and “generator” are generic terms that are not limited to any specific implementation. We generally intend the invention to broadly encompass software, hardware, firmware, or combination implementations. Nevertheless, certain claims may use terms like “module,” “circuit,” or “computer-executable instructions” to define a more specific implementation. We use the term “module” to refer to a tool that is implemented in software. We use the term “circuit” to refer to a tool that is implemented in hardware. We use the phrase “computer-executable instructions” to refer to instructions that, when executed by a computer, perform a certain function.

We describe various tools separately (e.g. we describe the standard question selector 1112 separately from the question synonym selector 1114) for ease of understanding and to describe logical differences in the functions performed by each tool. We do not suggest or imply, however, that the tools must be physically separate. Rather, a skilled artisan will appreciate, in light of this disclosure, that two tools described herein can be combined into a single tool that performs both functions described herein. Conversely, the functionality of a single tool described herein can be divided and performed by multiple tools. In this regard, a module comprises any plurality of instructions that cooperate to perform one or more specified functions, without regard to whether the instructions are stored in a single or multiple files, procedures, functions, methods, objects, or other programming organizational units.

Each database described herein comprises a collection of data that is encoded and stored in machine-readable form. The term “database,” as used herein, refers broadly to any such data collection and does not require any particular format or data access tool. Thus, while “database” encompasses common commercially-available databases such as those compatible with Structured Query Language or distributed by companies such as Oracle, Sybase, Progress, the term “database” is not limited to these databases. Rather, the term “database” also includes text files, binary files in any format, spreadsheet files, word processing files, or any other collection of data that is encoded and stored in machine-readable form.

Moreover, we use the term “database to refer to a logical collection of data, not necessarily to a collection of data stored in the same physical location. A skilled artisan will appreciate that databases can be physically implemented according to many different architectures. For example, in a system such as the system 1100, the standard questions database 1102 can be stored physically separate from the synonym questions database 1104. Alternatively, the standard questions database 1102 and the synonym questions database 1104 can be stored physically together, such as in a single hard drive, or the two databases can even be stored together in a single file such that they may be deemed to be a single database. As such, it will be appreciated that the different databases described herein are depicted in the figures and described in this written description as separate databases for ease of understanding and to emphasize the different logical functions performed by each database, and not to limit the exact physical architecture of the databases. Databases that are described as multiple databases can be combined into a single physical database and databases described as single databases can be divided into multiple physical databases.

It will be recognized by those skilled in the art that various modifications may be made to the illustrated and other embodiments described above, without departing from the broad inventive scope thereof. It will be understood therefore that the invention is not limited to the particular embodiments or arrangements disclosed herein. The features, components, and advantages of the various embodiments set forth herein are optional and not required, and do not limit any claim that does not have an express limitation. Moreover, any limitation that appears in one claim does not limit any other claim, except that a dependent claim incorporates the limitations of the claims from which it depends. Accordingly, a skilled artisan would, in light of this disclosure, interpret the claims to include only those limitations expressly claimed therein and to not include any limitations not expressly claimed therein.

We claim:

1. A point of license system, comprising:
at least one computer processor;
a memory;
a data transmission port;
a data reception port; and
a program stored at least in part in the memory which, when executed by the at least one computer processor, generates first output signals transmitted from the data transmission port to prompt a user to provide first business license data, the first business license data representing information useful for determining whether to issue a business license, the program responsive to first input signals received at the data reception port representative of the first business license data to generate second output signals transmitted from the data transmission port to prompt a user to provide first non-business license data, the first non-business license data indicative of at least one advertising decision made by the user.

2. The point of license system of claim 1, wherein the program is responsive to second input signals received at the data reception port representative of the first non-business license data to generate third output signals transmitted from the data transmission port to inform at least one advertiser about the at least one advertising decision made by the user.

3. The point of license system of claim 1, wherein the data transmission port and the data reception port are the same port.

4. A point of license system, comprising:
at least one computer processor;
a memory;
a data transmission port;
a data reception port; and
a program stored at least in part in the memory which, when executed by the at least one computer processor, generates first output signals transmitted from the data transmission port to prompt a user to provide first business license data, the first business license data representing information useful for determining whether to issue a business license, the program responsive to first input signals received at the data reception port representative of the first business license data to generate second output signals transmitted from the data transmission port to prompt a user to provide first non-business license data, the first non-business license data indicative of at least one sponsorship decision made by the user.

5. The point of license system of claim 4, wherein the sponsorship decision indicates whether the user will agree to sponsor an event or an organization.

6. The point of license system of claim 5, wherein the program is responsive to second input signals received at the data reception port representative of the first non-business license data to generate third output signals transmitted from the data transmission port to inform another party about the at least one sponsorship decision made by the user.

7. The point of license system of claim 4, wherein the data transmission port and the data reception port are the same port.

8. A point of license system, comprising:
at least one computer processor;
a memory;
a data transmission port;
a data reception port; and
a program stored at least in part in the memory which, when executed by the at least one computer processor, generates first output signals transmitted from the data transmission port to prompt a user to provide first business license data, the first business license data representing information useful for determining whether to issue a business license for a first business, the program responsive to first input signals received at the data reception port representative of the first business license data to generate second output signals transmitted from the data transmission port to prompt a user to provide first non-business license data, the first non-business license data indicative of at least one bid registration decision made by the user.

9. The point of license system of claim 8, wherein the bid registration decision indicates whether the user will agree to register the first business to receive information about items for which the first business may submit bids.

10. The point of license system of claim 9, wherein the program is responsive to second input signals received at the data reception port representative of the first non-business license data to generate and store data indicating that the first business is registered to receive information about items for which the first business may submit bids.

11. The point of license system of claim 8, wherein the data transmission port and the data reception port are the same port.

12. A license application system, comprising:
at least one computer processor;
a memory;
a communication port;
a data entry device; and
a program stored at least in part in the memory which, when executed by the at least one computer processor, receives first input signals from the communication port, the first input signals representing one or more prompts prompting a user to provide first business license data, the first business license data representing information useful for determining whether to issue a business license for a first business, the program responsive to first data entry signals received from the data entry device to generate first output signals transmitted to the communication port, the first output signals representative of the first business license data, the program responsive to second input signals received from the communication port to prompt a user to provide first non-business license data, the first non-business license data indicative of at least one advertising decision made by the user.

13. The license application system of claim 12 wherein the advertising decision indicates whether the first business will agree to advertise products or services.

14. The license application system of claim 13 wherein the second input signals represent at least one manner in which products or services may be advertised.

15. A license application system, comprising:
at least one computer instruction processor;
a memory;
a communication port;
a data entry device; and
a program stored at least in part in the memory which, when executed by the at least one computer instruction processor, receives first input signals from the communication port, the first input signals representing one or more prompts prompting a user to provide first business license data, the first business license data representing information useful for determining whether to issue a business license for a first business, the program responsive to first data entry signals received from the data entry device to generate first output signals transmitted to the communication port, the first output signals representative of the first business license data, the program responsive to second input signals received from the communication port to prompt a user to provide first non-business license data, the first non-business license data indicative of at least one sponsoring decision made by the user.

16. The license application system of claim 15 wherein the sponsoring decision indicates whether the first business will agree to sponsor an event or an organization.

17. The license application system of claim 15 wherein the second input signals represent at least one sponsorship opportunity.

18. A license application system, comprising:
at least one computer instruction processor;
a memory;
a communication port;
a data entry device; and
a program stored at least in part in the memory which, when executed by the at least one computer instruction processor, receives first input signals from the communication port, the first input signals representing one or more prompts prompting a user to provide first business license data, the first business license data representing information useful for determining whether to issue a business license for a first business, the program responsive to first data entry signals received from the data entry device to generate first output signals transmitted to the communication port, the first output signals representative of the first business license data, the program responsive to second input signals received from the communication port to prompt a user to provide first non-business license data, the first non-business license data indicative of at least one bid registration decision made by the user.

19. The license application system of claim 18 wherein the bid registration decision indicates whether the user will agree to register the first business to receive information about items for which the first business may submit bids.

20. The license application system of claim 18 wherein the program is responsive to second data entry signals received from the data entry device to generate second output signals transmitted to the communication port, the second output signals representative of the at least one bid registration decision.

21. A point-of-license data collection and indexing system comprising:
a form database comprising electronic forms that each define data fields for license business data that a business is requested to provide to apply for a license;
a business database configured to store license business data and non-license business data comprising business data that a business is not required to provide to apply for a license;
a data entry tool configured to commence a data entry session, to retrieve at least one of the electronic forms from the forms database, serve the defined data fields to a web browser during the data entry session such that the web browser can prompt a user to enter data associated with the defined data fields, serve additional data fields to the web browser during the data entry session seeking non-license business data such that the web browser can prompt the user to enter data associated with the additional data fields, to receive license business data and non-license business data from the web browser, and to cause the license business data and the non-license business data to be stored in the business database;
a rules database comprising information defining rules for determining associations between items of data stored in the business database;
a data association engine configured to use rules stored in the rules database to determine associations between items of data stored in the business database so as to organize the business database to allow the business database to be searched using a search engine; and
a reporting tool configured to search the business database and generate reports based on the business database, to make at least a portion of the license business data accessible to a government, and to make at least a portion of the non-license business data accessible to the public using a search engine.

22. The system of claim 21, further comprising form design tools configured to allow a government user to define forms for entry into the form database.

23. The system of claim 22, further comprising a standard questions database comprising common data fields for a licensing form, wherein the form generation tools comprise a standard questions selector configured to allow the government user to select one or more of the common data fields stored in the standard questions database for inclusion on a form.

24. The system of claim 22, further comprising a fee calculation rules database comprising calculation rules that may be combined to define fee calculation logic for calculating fees for a business applying for a license, wherein the form generation tools comprise a fee calculation definition tool configured to allow the government user to select and combine one or more of the fee calculation rules to define fee calculation logic.

25. The system of claim 24, wherein the fee calculation rules are associated with business classifications and the fee calculation definition tool is configured to allow the government user to define fee calculation rules that are specific to businesses having particular classifications.

26. The system of claim 21, further comprising an advertising vendor database comprising associations between advertising options and business characteristics and an advertisement selector configured, during the data entry session, to determine one or more advertising options for the business for which data is being entered, the determination being based on at least one business characteristic of the business and at least one association between the business characteristic and at least one advertising option, and to present the advertising options to the business for selection.

27. The system of claim 21, further comprising an organization database comprising information about organizations and opportunities to sponsor the organizations and associations between the organizations and opportunities of sponsorship and business characteristics, and a sponsorship tool configured, during the data entry session, to determine one or more sponsorship opportunities for the business for which data is being entered, the determination being based on at least one business characteristic of the business and at least one association between the business characteristic and at least one organization or sponsorship opportunity, and to present the sponsorship opportunities to the business for selection.

28. The system of claim 21, further comprising a business opportunity database comprising information about opportunities for businesses to enter into business transactions and associations between the business opportunities and business characteristics, and a business opportunity search tool configured to find one or more business opportunities for a business, the determination being based on at least one business characteristic of the business and at least one association between the business characteristic and at least one business opportunity, and to present the business opportunity to the business for response.

29. A point-of-license data entry system comprising:
a display;
a data entry device; and
a terminal configured to commence a data entry session, to receive license data fields pertaining to data that a business is requested to provide in a process of applying for a license, to receive non-license data fields seeking non-license business data pertaining to data that the business is not required to provide in the process of applying for a license, to prompt a user to enter information during the session into the license data fields and the non-license data fields, and to transmit the entered information for storage in a business database, wherein the non-license data fields include hours of operation of the business.

30. The system of claim 29, wherein the terminal is further configured to receive, during the data entry session, one or more advertisement options chosen based on an association between at least one characteristic of the business and the advertisement options, and to select one or more of the advertisement options so as to begin a process of advertising the business via the selected advertisement options.

31. The system of claim 29, wherein the terminal is further configured to receive, during the data entry session, one or more organization sponsorship options chosen based on an association between at least one characteristic of the business and the organization sponsorship options, and to select one or more of the organization sponsorship options so as to begin a process of sponsoring organizations in accordance with the selected advertisement options.

32. The system of claim 29, wherein the terminal is further configured to receive, one or more business opportunities chosen based on an association between at least one characteristic of the business and the business opportunities, to allow a user to enter a response to the business opportunities, and to transmit the response.

33. A method of providing a service at a point-of-license, the method comprising:
executing a computer-based process to commence a business license data entry session;
obtaining first business data from an applicant for a business license during the data entry session; and
obtaining advertising data from the applicant during the data entry session, the advertising data indicative of a decision to advertise products or services related to the first business data.

34. The method of claim 33, further comprising presenting a first set of advertising options to the applicant during the data entry session.

35. The method of claim 34, further comprising selecting the first set of advertising options based on a relationship between the first business data and each advertising option in the first set.

36. The method of claim 33, further comprising:
storing advertising options;
associating one or more business characteristics with each of the stored advertising options;
selecting a first set of advertising options based on the first business data matching at least one business characteristic that is associated with each of the first set of advertising options; and
presenting the first set of advertising options to the applicant for selection by the applicant.

37. The method of claim 33, further comprising charging the applicant a fee for advertising services.

38. A method of providing a service at a point-of-license, the method comprising:
executing a computer-based process to commence a business license data entry session;
obtaining first business data from an applicant for a business license during the data entry session; and
obtaining organization sponsorship data from the applicant during the data entry session, the organization sponsorship data indicative of a decision to sponsor an organization having a relationship to the first business data.

39. The method of claim 38, further comprising presenting a first set of organization sponsorship options to the applicant during the data entry session.

40. The method of claim 39, further comprising selecting the first set of organization sponsorship options based on a relationship between the first business data and each organization sponsorship option in the first set.

41. The method of claim 38, further comprising:
storing organization sponsorship options;
associating one or more business characteristics with each of the stored organization sponsorship options;
selecting a first set of organization sponsorship options based on the first business data matching at least one business characteristic that is associated with each of the first set of organization sponsorship options; and
presenting the first set of organization sponsorship options to the applicant for selection by the applicant.

42. The method of claim 38, further comprising charging the applicant a fee for organization sponsorship services.

43. The method of claim 38, further comprising:
requesting approval from an organization selected for sponsorship; and
performing a transaction related to sponsorship of the organization upon receiving approval from the organization of the sponsorship.

44. A method of providing a service at a point-of-license, the method comprising:
executing a computer-based process to commence a business license data entry session;
obtaining first business data from an applicant for a business license during the data entry session;
obtaining an indication from the applicant during the data entry session that the applicant wants to have access to business opportunities related to the first business data;
granting access to the business opportunities;
selecting a first set of business opportunities related to the first business data; and
presenting the first set of business opportunities to a business user associated with the applicant.

45. The method of claim 44, further comprising receiving a request from the business user associated with the applicant to search for business opportunities related to the first business data.

46. The method of claim 44, further comprising receiving a request from the business user to receive alerts of business opportunities, wherein the operation of selecting a first set of business opportunities is performed periodically, and wherein the operation of presenting the first set of business opportunities is performed by transmitting the first set of business opportunities to the business user.

47. The method of claim 44, further comprising:
storing business opportunities;
associating one or more business characteristics with each of the stored business opportunities; and
selecting the first set of business opportunities to the business user based on the first business data matching at least one business characteristic that is associated with each of the first set of business opportunities.

48. The method of claim 44, further comprising charging the applicant a fee for business opportunity services.

49. A point of license system, comprising:
at least one computer instruction processor;
a memory;
a data transmission port;
a data reception port; and
a program stored at least in part in the memory which, when executed by the at least one computer processor, generates first output signals transmitted from the data transmission port to prompt a user to provide first business license data, the first business license data representing information useful for determining whether to issue a business license for a first business, the program responsive to first input signals received at the data reception port representative of the first business license data to generate second output signals transmitted from the data transmission port to prompt the user to provide first non-business license data, the first non-business license data descriptive of at least one aspect of the first business, the program generating third output signals transmitted from the data transmission port to prompt the user to provide second non-business license data, the second non-business license data representing a decision as to whether the first business will agree to advertise products and services, the program generating fourth output signals transmitted from the data transmission port to prompt the user to provide third non-business license data, the third non-business license data representing a decision as to whether the first business will agree to sponsor at least one event or organization, the program generating fifth output signals transmitted from the data transmission port to prompt the user to provide fourth non-business license data, the fourth non-business license data representing a decision as to whether the first business will agree to receive information about items for which it may submit bids.

50. The point of license system of claim 49 wherein the program uses first non-business license data received at the data reception port to select first advertising options and generates sixth output signals transmitted from the data transmission port, the sixth output signals representative of the selected advertising options.

51. The point of license system of claim 49 wherein the program uses first non-business license data received at the data reception port to select sponsorship options and generates sixth output signals transmitted from the data transmission port, the sixth output signals representative of the selected sponsorship options.

52. The point of license system of claim 49, further comprising:
a search engine; and
a database, wherein the first business license data includes geographical information describing a location of the first business, wherein the program stores the geographical information in the database in association with the first business, wherein the program stores the first non-business license data in the database in association with the first business, and where the search engine receives search parameters including a first parameter indicative of a geographical region and a second parameter indicative of an aspect of a business, and compares the first parameter to the geographical information stored in the database and compares the second parameter to the first non-business license data in the database and generates search result information indicative of the first business.

53. The point of license system of claim 49, wherein the data transmission port and the data reception port are the same port.

54. A point of license system, comprising:
at least one computer processor;
a memory;
a data transmission port;
a data reception port; and
a program stored at least in part in the memory which, when executed by the at least one computer processor, generates first output signals transmitted from the data transmission port to prompt a user to provide first business license data, the first business license data representing information useful for determining whether to issue a business license for a first business, the program responsive to first input signals received at the data reception port representative of the first business license data to generate second output signals transmitted from the data transmission port to prompt a user to provide first non-business license data, the first non-business license data descriptive of at least one aspect of the first business, the program responsive to second input signals received at the data reception port representative of the first non-business license data to generate third output signals indicative of at least one selected product or service, the program comparing at least a portion of the first non-business license data to stored information representing one or more attributes of each of a plurality of products and services to select the at least one selected product or service.

55. The point of license system of claim 54 wherein the third output signals are transmitted from the data transmission port.

56. The point of license system of claim 54 wherein the data transmission port and the data reception port are the same port.
